(19) United States
(12) Patent Application Publication
(10) Pub. No.: US 2025/0361086 A1
(43) Pub. Date: Nov. 27, 2025

(54) AUTOMATED STORAGE AND RETRIEVAL SYSTEM

(71) Applicant: THARSUS LIMITED, Northumberland (GB)

(72) Inventors: Brian Andrew PALMER, Stocksfield (GB); David Peter SWAN, East Boldon (GB); Paul FEATONBY, Wylam (GB); Roger QUEMBY, Oakham (GB)

(21) Appl. No.: 18/872,763

(22) PCT Filed: Jun. 7, 2023
(86) PCT No.: PCT/GB2023/051484

§ 371 Date: Dec. 6, 2024

(30) Foreign Application Priority Data
Jun. 7, 2022 (GB) 2208354.7
Sep. 9, 2022 (GB) 2213230.2

(51) Int. Cl. B65G 1/04; B65G 1/137

(52) U.S. Cl. CPC B65G 1/0478; B65G 1/1373

(57) ABSTRACT

The present disclosure provides an automated storage and retrieval system (1) for storing goods within a storage and order processing facility. The automated storage and retrieval system comprises a framework. configured to form at least part of a multi-level matrix comprising a plurality of vertically-stacked levels (2). The system also comprises a plurality of tile units (3), configured so as to in use form a grid on each level, each grid comprising a substantially continuous substantially planar upper surface. The system also comprises a plurality of goods transport means (4) configured to locate onto and move across the substantially continuous substantially planar upper surfaces of the grids. The tile units further comprise a drive means configured to move the goods transport means on top of the grids. The system further includes a control system configured to adjust the drive means to alter the position of the goods transport means on the grid.

This invention relates to an automated storage and retrieval system for goods within an order processing facility, to a method of operating an automated storage and retrieval system, and to a tile unit for an automated storage and retrieval system.

### BACKGROUND

In order to reduce the time it takes to fulfil an order, it has become more common to implement local order processing facilities that are usually smaller and located closer to the end destination of goods (e.g., within urban areas). Such fulfilment centres are termed forward positioned order processing facilities and typically receive goods from a centralised warehouse and store the goods until they are removed for order fulfilment. Such forward positioned order processing facilities are used to store a large variety of goods, for example groceries, and there is a need for such facilities to have a high storage density to minimise footprint and a low latency retrieval to provide efficient order fulfilment. Automated storage and retrieval systems are often implemented in such forward positioned order processing facilities.

Automated storage and retrieval systems typically consist of a number of storage locations formed in storage racks (e.g., shelving units) separated by aisles that permit a crane or similar to access each storage location for depositing or retrieving goods. In each storage location goods may be stored in totes, cages, or pallets. In some examples, the aisles are fixed to allow the crane to access each storage location. In other examples, the storage racks can be moved to change the location of the aisle and thereby increase storage density. However, this increases retrieval time as the storage racks have to be moved before the crane can reach particular storage locations. Other automated storage and retrieval systems consists of a shuttle system using conveyors to move goods between different locations, or a vertical or horizontal carousel arrangement. Depending on the goods, they may be handled directly or placed in containers such as totes for transport and storage.

There exists a need for an automated storage and retrieval system for forward positioned order processing facilities that achieves high storage density with low latency retrieval.

### BRIEF SUMMARY OF THE DISCLOSURE

In accordance with the present invention, there is provided an automated storage and retrieval system for storing goods within a storage and order processing facility. The automated storage and retrieval system comprising:
a framework, configured to form at least part of a multi-level matrix comprising a plurality of vertically-stacked levels;
a plurality of tile units, configured so as to in use form a grid on each level, each grid comprising a substantially continuous substantially planar upper surface;
a plurality of goods transport means configured to locate onto and move across the substantially continuous substantially planar upper surfaces of the grids;
the tile units further comprising a drive means configured to move the goods transport means on top of the grids; and
a control system configured to adjust the drive means to alter the position of the goods transport means on the grid.

In examples, the automated storage and retrieval system further comprises at least one lift means configured to move the goods transport means between levels. The control system may additionally control the lift means.

In examples, the levels are at least partly overlapping. In examples, the levels are substantially the same size and substantially fully overlapping.

In examples, the automated storage and retrieval system comprises an output station. The output station may be an end row or column of tile units in the grid of tile units. In examples, the output station comprises a pick station, for example for an operator or a robot to remove goods from the automated storage and retrieval system. The output station, for example the pick station, may comprise a conveyor. The conveyor may comprise a plurality of tile units arranged in a line. In examples, the lift means is arranged to align with the output station in one position.

Accordingly, goods can be moved about the automated storage and retrieval system by operating the tile units and lift means to move the goods transport means. Goods can be output from the automated storage and retrieval system by operating the tile units and lift means to move the goods transport means to the output station.

In examples, the automated storage and retrieval system further comprises an input station. The input station and the output station may be separated, for example on different or opposite sides of a grid of the automated storage and retrieval system, or on different levels of the automated storage and retrieval system. In some examples, the input station and the output station are co-located, for example as a pick station where goods can be loaded into and unloaded from the automated storage and retrieval system. In some examples, the input station may comprise a conveyor, for example a conveyor comprising a plurality of tile units. Goods can be input into the automated storage and retrieval system by operating the tile units and lift means to move the goods transport means from the input station into the grid.

In examples, the drive means comprises a drive wheel arranged to engage an underside of the goods transport means and rotate to move the goods transport means. Rotation of the drive wheel when in engagement with the goods transport means will cause the goods transport means to move towards an adjacent tile unit in the grid.

In examples, the drive wheel is rotatable (swivelable) about an axis perpendicular to the substantially planar upper surface of the tile unit such that the drive wheel can be rotated into a different orientation relative to the goods transport means for moving the goods transport means in different directions. In examples, the drive wheel is rotatable (swivelable) about the axis perpendicular to the substantially planar upper surface by 90 degrees. In examples, rotation of the drive wheel about the axis perpendicular to the substantially planar upper surface is limited to 90 degrees. By rotating the drive wheel through 90 degrees and operating the drive wheel in either direction the tile unit is able to move a goods transport means to any adjacent tile unit in a row direction or in a column direction.

In examples, the drive wheel is mounted to the tile unit by a pivot that permits rotation (swivelling) of the drive wheel about the axis perpendicular to the substantially planar upper surface. In examples, the drive means includes a motor mounted to the drive wheel on the pivot, the motor being operable to rotate (swivel) the drive wheel in either direction to move the goods transport means. In examples, the drive means includes a rotation mechanism operable to rotate (swivel) the drive wheel about the axis perpendicular to the substantially planar upper surface.

In examples, the drive means comprises a plurality of drive wheels, each drive wheel being as described above. The drive means may comprise two, three, four or more drive wheels. The rotation mechanism may be operable to rotate (swivel) all of the drive wheels about axes perpendicular to the substantially planar upper surface. In examples, the rotation mechanism may be arranged to rotate (swivel) a first drive wheel in a first direction and a second drive wheel in a second direction. Advantageously, this may balance out any forces applied to the goods transport means during rotation of the drive wheels about the axes perpendicular to the substantially planar upper surface.

In examples, the goods transport means comprises wheel guides arranged to align with the or each drive wheel when the goods transport means is moving relative to the tile unit. The wheel guides may comprise grooves in an underside of the goods transport means. The wheel guides and the drive wheel may cooperate to restrain movement of the goods transport means in a linear direction towards an adjacent tile unit.

In examples, the goods transport means comprises a swivel recess arranged to align with the or each drive wheel when the goods transport means is aligned with the tile unit. The swivel recess may be arranged to permit rotation of the or each drive wheel about the axis perpendicular to the substantially planar upper surface of the tile unit. The swivel recess can therefore prevent movement of the goods transport means during rotation of the or each drive wheel about the axes perpendicular to the substantially planar upper surface.

In examples, each tile unit further comprises a guide roller. In examples, each goods transport means comprises a groove. The guide roller engages the groove in the goods transport means to maintain alignment between the tile unit and the goods transport means during movement of the goods transport means. In examples, the guide roller is a roller ball guide, and the groove in the goods transport means is rounded. Accordingly, the roller ball guide and the rounded groove may act to self-centralise to align the goods transport means with the tile unit.

In examples, each tile unit comprises a seat and a removable section, the removable section comprising the drive means. In examples, the removable section is attachable to the seat by a latch. In examples, the removable section is attachable to the seat in a fastener-less manner. Accordingly, the removable section can be unlatched and removed from the seat in a simple manner without the need to remove fasteners. A replacement removable section (e.g., a repaired or new removable section) can then be inserted into the seat using the latch. As such, a robot may be able to provide such function to retrieve removable sections of tile units in the grid. The robot may additionally insert a new removable section. Such an operation may be carried out while the automated storage and retrieval system is still operating.

In examples, the seat comprises an electrical connector, and wherein the removable section comprises a corresponding electrical connector to connect with the electrical connector of the seat when the removable section is attached to the seat. Accordingly, the removable section electrically connects to the seat. The electrical connection may provide power and/or communications. The electrical connectors may be a plug and a socket.

In examples, the seat comprises a circuit board having a port for power and/or wired communications connections. If the port includes a communications port, the port may include an ethernet port for a communications connection to a network. In examples, each tile unit is connected to an adjacent tile unit and/or to a control system via the port. In examples, the circuit board comprises a memory storing address information for the tile unit. In examples, the tile units are configured to communicate with each other and/or with a control system using a point-to-point protocol. In examples, the port is only for a power connection. In examples, the tile unit, in particular the removable section, may include a wireless communications unit for wirelessly communicating with a control system and/or with other tile units. The wireless communications units of multiple tile units may form a mesh network. In some examples, tile units may have wired communications connections to one or more wireless communications hubs within the automated storage and retrieval system. The one or more wireless communications hubs may facilitate communication between tile units and/or between tile units and a control system.

In examples, each goods transport means comprises a container, for example a storage container such as a storage tote. In examples, each goods transport means comprises a plate on which a container or goods can be carried. The plate may be a skid plate. In examples, each goods transport means may comprise a container received on top of a plate. In examples, the automated storage and retrieval system may comprise a combination of containers received directly on tile units and/or plates received on tile units and/or containers on plates received on tile units.

In examples, at least some of the plurality of tile units comprises a sensor. Each goods transport means comprises a sensor element that is detectable by the sensor. In examples, the sensor element may be an RFID coil, in particular a passive RFID coil, and the sensor may be an RFID reader. In other examples, the sensor element may be a code, for example a barcode or QR code, and the sensor may be a camera or reader to read the code.

In accordance with the present invention, there is also provided an automated storage and retrieval system for an order processing facility containing goods held on goods transport means, the automated goods storage and retrieval system comprising:
a plurality of tile units arranged in a grid having rows and columns, each tile unit being adapted to support a goods transport means and comprising a drive unit operable to move the goods transport means to an adjacent tile unit in a row direction or in a column direction,
an output station for removing goods from the automated storage and retrieval system, the output station being positioned at an end of at least one of the columns of the grid, and
a control system configured to track the positions of the goods transport means within the grid and to control the drive units of the tile units to move the goods transport means to the output station for retrieval of goods, wherein the control system is configured to move a called goods transport means from a tile unit in the grid to the output station by:
   moving goods transport means in a column corresponding to the called goods transport means in the row direction to create an aisle in the column direction, and
   moving the called goods transport means along the aisle to the output station.

Accordingly, an aisle can be dynamically formed for moving the called goods transport means to the output station. This provides for low latency retrieval of the called goods transport means while allowing high storage density as permanent and fixed aisles are not needed. In such a system, only one free space is needed per row to allow aisles to be formed in any column, which provides high storage density.

In examples, the control system may be configured to simultaneously move a plurality of goods transport means in a row in the row direction. That is, the control system may operate tile units in a row to simultaneously move a plurality of goods transport means in the row direction to create an aisle. In other examples, the control system may be configured to successively move a plurality of goods transport means in a row in the row direction, i.e., one after another.

In examples, the aisle has a minimum length of at least two tile units in the column direction, for example a minimum length of at least three tile units in the column direction. The aisle may have a maximum length of 3 tile units, or 4 tile units. In examples, during movement of the called goods transport means along the aisle the control system is configured to move goods transport means in the row direction to close the aisle behind the called goods transport means. Such a dynamic aisle, which may be relatively short in comparison to the overall column length, allows further aisles to be dynamically formed at the same time.

In examples, the control system is configured to move a second called goods transport means from a tile unit in the grid to the output station by:
when the called goods transport means has passed by the row corresponding to the second called goods transport means, moving goods transport means in a column corresponding to the second called goods transport means in the row direction to create a second aisle in the column direction for the second called goods transport means, and
moving the second called goods transport means along the second aisle to the output station.

That is, multiple dynamic aisles may be simultaneously formed for moving multiple goods transport means to the output station. This improves the throughput of the system and provides low latency retrieval.

In examples, at a maximum storage density, one tile unit in each row is empty. In some examples, the automated goods storage and retrieval system may have additional rows and/or columns of tile units provided for other uses. In such examples the automated goods storage and retrieval system forms a part of a larger system comprising tile units arranged in rows and columns. In other examples, the maximum storage density may be up to 100% (i.e., with all tile units occupied). 100% tile unit occupancy is possible if the goods transport means are already arranged in the output sequence as they are fed into the automated storage and retrieval system, or if all of the goods transport means on a level (or across all levels) hold the same goods. In other examples, at the maximum storage density at least one tile unit on each level is empty. This allows the goods transport means to be moved such that any goods transport means can be moved to the output station.

In examples, the automated goods storage and retrieval system comprises a plurality of levels arranged on top of each other, each level having a plurality of tile units arranged in a grid. The levels may be aligned with each other (i.e., completely overlapping to form a cube), or partially overlapping. Different levels may have an identical size and layout or a different size and layout.

In examples, the automated goods storage and retrieval system may further comprise at least one lift arranged to move goods transport means between levels and/or between a level and the output station. The lift may comprise a tile unit.

In examples, the automated goods storage and retrieval system may comprise a first lift arranged to move goods transport means from a level into the output station, and a second lift arranged to move goods transport means from the output station onto a level. The first and second lifts may be located at opposite ends of a conveyor of the output station so that goods transport means move across the output station in the same direction for retrieval and depositing goods in the goods transport means.

In examples, the output station comprises a pick station, for example for an operator or a robot to remove goods from the automated storage and retrieval system. In examples, the goods transport means themselves (e.g., a storage container) may be removed, or goods can be removed from the goods transport means. The output station, for example the pick station, may comprise a conveyor. The conveyor may comprise a plurality of tile units arranged in a line. In examples, the conveyor may be at waist-height for an operator or a robot. In examples, the lift means is arranged to align with the output station in one position.

Accordingly, goods can be moved about the automated storage and retrieval system by operating the tile units and lift to move the goods transport means. Goods can be output from the automated storage and retrieval system by operating the tile units and lift to move the goods transport means to the output station.

In examples, the automated storage and retrieval system further comprises an input station. The input station and the output station may be separated, for example on different or opposite sides of a grid of the automated storage and retrieval system, or on different levels of the automated storage and retrieval system. In some examples, the input station and the output station are co-located, for example as a pick station where goods can be loaded into and unloaded from the automated storage and retrieval system. In some examples, the input station may comprise a conveyor, for example a conveyor comprising a plurality of tile units. Goods can be input into the automated storage and retrieval system by operating the tile units and lift to move the goods transport means from the input station into the grid.

In examples, each goods transport means comprises a container, for example a storage container such as a storage tote. In examples, each goods transport means comprises a plate on which a container or goods can be carried. The plate may be a skid plate. In examples, each goods transport means may comprise a container received on top of a plate. In examples, the automated storage and retrieval system may comprise a combination of containers received directly on tile units and/or plates received on tile units and/or containers on plates received on tile units.

In accordance with the present invention, there is also provided a method of operating an automated storage and retrieval system for an order processing facility containing goods held on goods transport means, the automated storage and retrieval system comprising a plurality of tile units arranged in a grid having rows and columns, each tile unit being adapted to support a goods transport means and comprising a drive unit operable to move the goods transport means to an adjacent tile unit in a row direction or in a column direction, and an output station for removing goods from the goods transport means, the output station being positioned at an end of at least one of the columns of the grid,
wherein the method comprises moving a called goods transport means from a tile unit in the grid to the output station by:
   moving goods transport means in a column corresponding to the called goods transport means in the row direction to create an aisle in the column direction, and
   moving the called goods transport means along the aisle to the output station.

Accordingly, an aisle can be dynamically formed for moving the called goods transport means to the output station. This provides for low latency retrieval of the called goods transport means while allowing high storage density as permanent and fixed aisles are not needed. In such a system, only one free space is needed per row to allow aisles to be formed in any column, which provides high storage density.

In examples, the method may comprise simultaneously moving a plurality of goods transport means in a row in the row direction. That is, a plurality of goods transport means may be moved in the row direction to create an aisle. In other examples, the method may comprise successively moving a plurality of goods transport means in a row in the row direction.

In examples, the aisle has a minimum length of at least two tile units in the column direction, for example a minimum length of at least three tile units in the column direction. The aisle may have a maximum length of 3 tile units, or 4 tile units. In examples, during movement of the called goods transport means along the aisle, the method may further comprise moving goods transport means in the row direction to close the aisle behind the called goods transport means. Such a dynamic aisle, which may be relatively short in comparison to the overall column length, allows further aisles to be dynamically formed at the same time.

In examples, the method may further comprise moving a second called goods transport means from a tile unit in the grid to the output station by:
when the called goods transport means has passed by the row corresponding to the second called goods transport means, moving goods transport means in a column corresponding to the second called goods transport means in the row direction to create a second aisle in the column direction for the second called goods transport means, and
moving the second called goods transport means along the second aisle to the output station.

That is, multiple dynamic aisles may be simultaneously formed for moving multiple goods transport means to the output station. This improves the throughput of the system and provides low latency retrieval.

In examples, the output station comprises a pick station, for example for an operator or a robot to remove goods from the automated storage and retrieval system. The output station, for example the pick station, may comprise a conveyor. The conveyor may comprise a plurality of tile units arranged in a line. In examples, the conveyor may be at waist-height for an operator or a robot. In examples, the lift means is arranged to align with the output station in one position.

Accordingly, goods can be moved about the automated storage and retrieval system by operating the tile units and lift to move the goods transport means. Goods can be output from the automated storage and retrieval system by operating the tile units and lift to move the goods transport means to the output station.

In examples, the automated storage and retrieval system further comprises an input station. The input station and the output station may be separated, for example on different or opposite sides of a grid of the automated storage and retrieval system, or on different levels of the automated storage and retrieval system. In some examples, the input station and the output station are co-located, for example as a pick station where goods can be loaded into and unloaded from the automated storage and retrieval system. In some examples, the input station may comprise a conveyor, for example a conveyor comprising a plurality of tile units. Goods can be input into the automated storage and retrieval system by operating the tile units and lift (if provided) to move the goods transport means from the input station into the grid.

In examples, each goods transport means comprises a container, for example a storage container such as a storage tote. In examples, each goods transport means comprises a plate on which a container or goods can be carried. The plate may be a skid plate. In examples, each goods transport means may comprise a container received on top of a plate. In examples, the automated storage and retrieval system may comprise a combination of containers received directly on tile units and/or plates received on tile units and/or containers on plates received on tile units.

In accordance with a further aspect of the present invention, there is also provided a tile unit for an automated storage and retrieval system, the tile unit comprising:
a seat defining a frame for assembly with other seats to define a framework of the automated storage and retrieval system, and
a removable section comprising a drive unit operable for driving movement of a goods transport means received on the tile unit,
wherein the removable section can be removed from the seat.

In examples, the removable section is attachable to the seat by a latch. In examples, the removable section is attachable to the seat in a fastener-less manner. Accordingly, the removable section can be unlatched and removed from the seat in a simple manner without the need to remove fasteners. A replacement removable section (e.g., a repaired or new removable section) can then be inserted into the seat using the latch. As such, a robot may be able to provide such function to retrieve removable sections of tile units in the grid. The robot may additionally insert new removable sections. Such an operation may be carried out while the automated storage and retrieval system is still operating. In examples, the removable section is removable from the seat by lifting the removable section from the seat. In examples, the tile unit is removable from an underside of the seat.

In examples, the removable section comprises a sliding latch that is moveable between a retracted position that permits removal of the removable section from the seat, and an extended position in which the sliding latch engages the frame to attach the removable section to the seat. In examples, the sliding latch is spring-biased towards the extended position. In examples, an electrical connector is provided on the sliding latch such that sliding the sliding latch can connect/disconnect the electrical connector and a corresponding electrical connector on the seat.

In examples, the seat comprises an electrical connector, and the removable section comprises a corresponding electrical connector to connect with the electrical connector of the seat when the removable section is attached to the seat. Accordingly, the removable section electrically connects to the seat. The electrical connection may provide power and/or communications. The electrical connectors may be a plug and socket.

In examples, the seat comprises a circuit board having a port for power and/or communications connections. If the port includes a communications port, the port may include an ethernet port for a communications connection to a network. In examples, each tile unit is connected to an adjacent tile unit and/or to a control system via the port. In examples, the circuit board comprises a memory storing address information for the tile unit. In examples, the tile units are configured to communicate with each other and/or with a control system using a point-to-point protocol. In examples, the port is only for a power connection. In examples, the tile unit, in particular the removable section, may include a wireless communications unit for wireless communicating with a control system and/or with other tile units.

In examples, the frame of the seat is attachable to a plurality of other seats of other tile units to form a grid of tile units, the tile units in the grid being aligned in rows and columns. The frame may be attachable directly to one or more other frames, or to a framework.

In examples, each goods transport means comprises a container, for example a storage container such as a storage tote. In examples, each goods transport means comprises a plate on which a container or goods can be carried. The plate may be a skid plate. In examples, each goods transport means may comprise a container received on top of a plate. In examples, the automated storage and retrieval system may comprise a combination of containers received directly on tile units and/or plates received on tile units and/or containers on plates received on tile units.

In accordance with a further aspect of the present invention, there is also provided an automated storage and retrieval system for an order processing facility. The automated storage and retrieval system comprises a plurality of the tile units as described above, the tile units being arranged in a grid such that the tile units form a substantially continuous substantially planar upper surface. The tile units may be arranged in a grid of rows and columns as described above.

In examples, each tile unit has a communication connection with a control system, e.g., a server, optionally via one or more hubs or switches. Additionally or alternatively, each tile unit may have a communications connection with at least one adjacent tile unit, for example a plurality of adjacent tile units. The communications connection(s) may be wired, e.g., ethernet, or wireless, e.g., UWB or BLE. The tile units are therefore connected in a communications network. A wireless communications network may form a mesh network. Each tile unit has an address within the network, which may for example include a grid coordinate (X, Y and Z coordinates). The tile units may communicate with the control system and/or with other tile units using a point-to-point protocol. The network and point-to-point protocol may allow individual tile units to communicate with each other to co-ordinate operation of drive units for moving goods transport means from one tile unit to another. The network and point-to-point protocol may allow the control system to provide instructions to individual tile units for operating the drive units for moving goods transport means from one tile unit to another. The control system may additionally track and/or control the positions of goods transport means within the automated storage and retrieval system. In some examples the automated storage and retrieval system comprises a plurality of levels and a lift, as described above, and the lift may be controlled by the control system. The lift may include a tile unit that is connected to the same network. The tile unit of the lift and/or the control system may communicate with an adjacent tile unit on a level so as to coordinate movement of goods transport means between the lift and the level.

In accordance with a further aspect of the present invention, there is also provided an automated goods storage and retrieval system for an order processing facility containing goods held on goods transport means, the automated goods storage and retrieval system comprising:
a framework having a plurality of grid locations arranged in rows and columns, each grid location comprising a seat;
a plurality of tile units, each tile unit being received in a seat at one of the grid locations in the framework, wherein each tile unit is adapted to support a goods transport means and comprises a drive unit operable to move the goods transport means to an adjacent tile unit in a row direction or in a column direction,
and wherein each tile unit is removable from its seat by lifting the tile unit from the seat.

Therefore, the tile units can be easily removed from the framework. The tile units may be removable without having to remove or unfasten any other components. This may allow tile units to be easily removed and retrieved from the grid, for example for maintenance or replacement. It also facilitates fast and easy assembly of the automated goods storage and retrieval system by simply lowering tile units into the seats of the framework.

In examples, each tile unit may comprise an electrical socket connection for connection to a corresponding electrical socket connection provided in the seat and/or in an adjacent tile unit and/or in a plug that connects adjacent tile units. Such an electrical socket connection provides an electrical connection between the tile unit and one or more of the seat (i.e., the framework), and/or an adjacent tile. Power may be provided to the tile units through the electrical socket connection. A control system may communicate with the tile units through the electrical socket connection. In examples, adjacent tile units are electrically connected to each other through the electrical socket connection and form a communications network for relaying control signals between a central control system and the tile units.

In examples, the electrical socket connection is oriented towards the seat, such that lifting the tile unit from the seat disconnects the electrical socket connection. In other examples, the electrical socket connection is oriented sideways and the seat comprises a corresponding electrical socket connection disposed on a side of the seat, such that sliding the tile unit into the seat connects the electrical socket connections. In either example, simply assembling the tile unit into the seat connects the electrical socket connections and the reverse, lifting the tile unit out of the seat, disconnects the electrical socket connections.

In examples, each goods transport means comprises a container, for example a storage container such as a storage tote. In examples, each goods transport means comprises a plate on which a container or goods can be carried. The plate may be a skid plate. In examples, each goods transport means may comprise a container received on top of a plate. In examples, the automated storage and retrieval system may comprise a combination of containers received directly on tile units and/or plates received on tile units and/or containers on plates received on tile units.

In accordance with a further aspect of the present invention, there is provided a tile unit for an automated goods storage and retrieval system comprising a framework having a plurality of seats arranged in a grid, each seat being adapted to receive the tile unit, wherein the tile unit is adapted to support a goods transport means and comprises:
a drive unit operable to move the goods transport means to an adjacent tile unit, and
an electrical socket connection for connection to a corresponding electrical socket connection provided in the seat and/or in an adjacent tile unit and/or in a plug that connects adjacent tile units so as to form an electrical connection between the tile unit and the framework and/or an adjacent tile unit and/or the plug that connects adjacent tile units.

In examples, the electrical socket connection may be oriented towards the seat, such that lifting the tile unit from the seat disconnects the electrical socket connection. In other examples, the electrical socket connection may be oriented sideways to connect to a corresponding electrical socket connection disposed on a side of the seat, such that sliding the tile unit into the seat connects the electrical socket connections. In some examples, the tile unit may be lifted (separated) from the seat from below.

The automated storage and retrieval system provides improved storage density because there are no fixed aisles between storage locations, while also providing low latency retrieval by creating dynamic aisles for movement of goods to the output station. Such an automated storage and retrieval system may be particularly beneficial for storing forward-located goods, such as groceries or other items where there are a large number of SKUs with unpredictable ordering patterns, and where retrieval time is important for order fulfilment.

In examples, each goods transport means comprises a container, for example a storage container such as a storage tote. In examples, each goods transport means comprises a plate on which a container or goods can be carried. The plate may be a skid plate. In examples, each goods transport means may comprise a container received on top of a plate. In examples, the automated storage and retrieval system may comprise a combination of containers received directly on tile units and/or plates received on tile units and/or containers on plates received on tile units.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

### BRIEF DESCRIPTION OF THE DRAWINGS

Embodiments of the invention are further described hereinafter with reference to the accompanying drawings, in which:

FIG. 1 shows an automated storage and retrieval system with multiple levels;

FIG. 2 shows a single level of the automated storage and retrieval system of FIG. 1;

FIG. 3 shows a top view of the level shown in FIG. 2;

FIG. 4 shows a part of the level shown in FIGS. 2 and 3, with some containers omitted;

FIGS. 5A and 5B schematically illustrate the formation of an aisle within the automated storage and retrieval system;

FIGS. 6A to 6C schematically illustrate the formation of multiple aisles within the automated storage and retrieval system;

FIGS. 7A and 7B illustrate a first example of a tile unit of the automated storage and retrieval system;

FIGS. 8A to 8C illustrate a second example of a tile unit of the automated storage and retrieval system;

FIGS. 9A to 9C illustrate a third example of a tile unit of the automated storage and retrieval system;

FIGS. 10A and 10B illustrate multiple tile units arranged in a grid in the automated storage and retrieval system;

FIGS. 11A and 11B illustrate example wheel guide formations of a storage tote or skid plate of the automated storage and retrieval system;

FIG. 12 illustrates a skid plate of the automated storage and retrieval system;

FIG. 13 illustrates a storage tote of the automated storage and retrieval system;

FIG. 14 illustrates how adjacent tile units of the automated storage and retrieval system are connected together, including an electrical connection;

FIG. 15 illustrates an alternative arrangement for forming an electrical connection with the tile unit;

FIGS. 16A to 16D illustrate a further example tile unit with a seat and a removable section.

### DETAILED DESCRIPTION

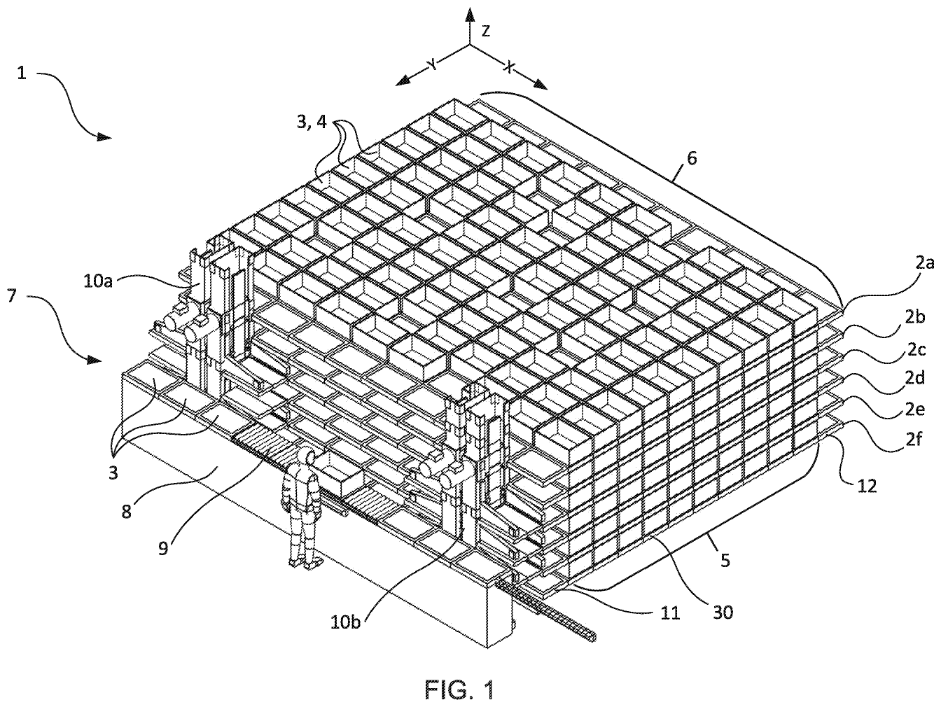

An embodiment of an automated storage and retrieval system 1 for goods within a storage and order processing facility is shown in overview in FIG. 1. The automated storage and retrieval system 1 is particularly suited to storage of forward-positioned goods, for example in-store storage of goods or in small distribution installations closer to the end destination of the goods than larger distribution installations. The automated storage and retrieval system 1 is particularly suited to storing various different goods. The goods are arranged in units of goods and are held in or on goods transport means within the automated storage and retrieval system 1. In the illustrated example the goods transport means are in storage containers, particularly storage totes 4. In other examples, described below, the goods may be received on a skid plate which is held in the automated storage and retrieval system 1, or in containers received on skid plates. The goods may be, for example, groceries, clothing, retail goods and the like as is typically provided in an on-demand store setting or for delivery. The automated storage and retrieval system 1 provides high density storage of such various goods with low latency retrieval, allowing orders to be fulfilled quickly and accurately.

The automated storage and retrieval system 1 is installed within a warehouse or similar location, in particular within a forward positioned order processing facility. Individual goods are shipped from widely-dispersed manufacturing or growing locations, and/or from a central distribution centre, to the order processing facility, which acts as a local distribution node. The goods can be stored in the automated storage and retrieval system 1, which acts both as a temporary storage unit and a means of assisting with distributing the goods as required.

In examples, the order processing facility may be a warehouse or part of a warehouse, and the automated storage and retrieval system 1 may be used to store and retrieve goods within the warehouse. In other examples, the order processing facility may be part of a factory facility, for example the automated storage and retrieval system 1 may be used to store goods or components that are retrieved and then transferred to an assembly line. In other examples, the order processing facility may be part of a retail facility (e.g., a shop), for example the automated storage and retrieval system 1 may be used to store and retrieve goods within the retail facility, such as in a store room. In other examples, the order processing facility may be part of a customer interaction system. For example, the automated storage and retrieval system 1 may be used for a vending or click-and-collect function where the customer can input the desired goods, which are then retrieved from the automated storage and retrieval system 1.

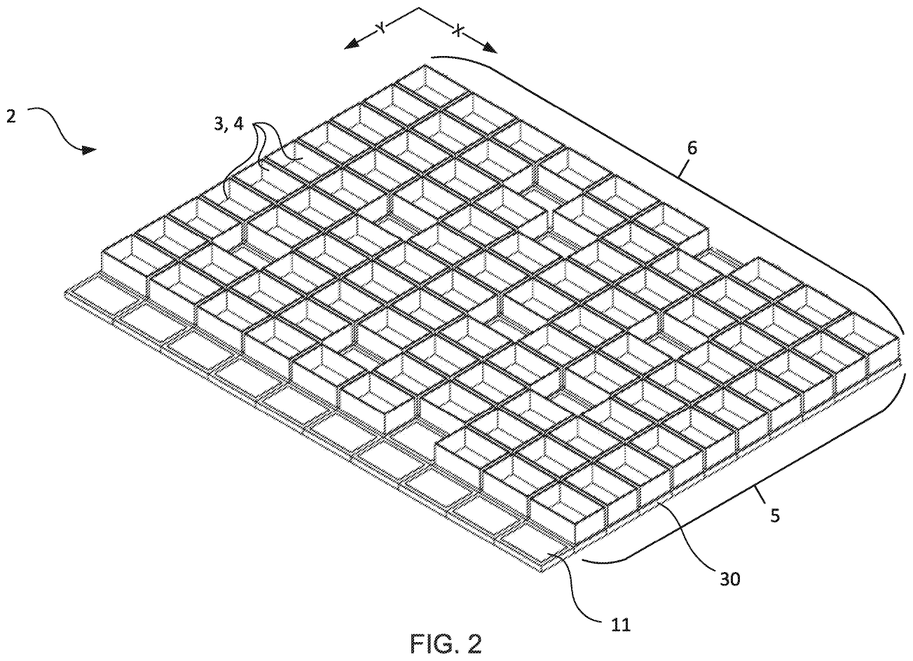

The automated storage and retrieval system 1 comprises a matrix formed from a number of substantially horizontally aligned levels 2a-2f stacked above and below one another on a framework 30, and an output station. The levels 2a-2f may alternatively be described as layers or tiers. In the described examples the output station is a pick station 7 where goods can be removed from the automated storage and retrieval system 1. Goods can be removed either manually, by an operator, or automatically or semi-automatically, for example using a robot. However, it will be appreciated that in other examples the output station may have other forms, for example an output conveyor that conveys goods away from the automated storage and retrieval system 1. The automated storage and retrieval system 1 also includes an input station for inputting goods into the automated storage and retrieval system 1. The input station and the output station 7 may be the same station, or they may be separate. FIGS. 2 to 6C show a single level 2 of the automated storage and retrieval system 1 shown in FIG. 1.

The framework 30 shown in FIG. 1 is configured to support a number of tile units 3 that are in use laid out in grids on the framework 30 to form the levels 2. The lowest level 2f of tile units 3 may be located directly on the floor of the warehouse, or may be raised up from the floor of the warehouse.

In use, each tile unit 3 is capable of supporting a goods transport means, in particular a storage container or skid plate. In the illustrated examples, the tile units 3 are adapted to support storage totes 4, which are standardised, open-topped boxes for holding goods. The storage tote 4 is a container holding the goods and, as described further below, is sized to fit on one of the tile units 3. However, as described below, the goods transport means may alternatively or additionally comprise a skid plate on which goods or a storage container are received.

In examples, each tile unit 3 is rectangular in plan view, and has a length of approximately 30 cm and a width of approximately 20 cm, or a length of approximately 80 cm and a width of approximately 60 cm. The tile units 3 may be arranged so that the corners of adjacent tile units are located in the same position as one another, and not offset (i.e. the inner corners of a set of four tile units arranged in a 2×2 pattern are all in the same location). Alternatively, there may be some gap between the edges of adjacent tile units 3, for example to accommodate a part of the framework 30.

The framework 30 is formed from steel beams or similar, connected at their ends and along their length with suitable fasteners such as bolts, rivets, or similar. The sides and ends of the matrix are open.

As shown, in the example of FIG. 1 the automated storage and retrieval system 1 comprises six levels 2a-2f but it will be appreciated that one or more levels 2a-2f may be provided. In some examples, the automated storage and retrieval system 1 may comprise a single level 2. In the example of FIG. 1, each level 2a-2f is the same size as the others—that is, formed from the same number of tile units 3 in the same layout. In the example of FIG. 1, the automated storage and retrieval system 1 has six levels 2a-2d and the height of the framework 30 is around 2.5 metres, although it will be appreciated that different numbers of levels 2 would change the height of the automated storage and retrieval system 1. In this example the automated storage and retrieval system 1 has a width, in a X direction, of 10 tile units 3 and a width of approximately 4 to 8 metres, for example 6 to 8 metres. In this example the automated storage and retrieval system 1 has a length, in the Y direction, of 12 tile units 3 and a length of approximately 4 to 6 metres, or for example 15 to 20 metres. However, it will be appreciated that in different installations the height, length and width may vary and can be adapted to fit the installation site (e.g., warehouse floor space and clearance). Accordingly, the number of levels 2 and the number of tile units 3 in the X and Y directions may vary accordingly. In addition, some tile units 3 may be omitted to accommodate other features of the installation site, such as columns or access points.

Each tile unit 3 in this embodiment is substantially the same size as every other, and appears square or rectangular when viewed in plan view. As shown in FIGS. 1 to 4B when a number of the tile units 3 are located side-by-side with one another in a level 2 they form a grid, made up of the individual squares/rectangles of each tile unit 3. In this way, each level 2a-2f of the system 1 comprises a grid of tile units 3. The tile units 3 are aligned in the Z (vertical) direction so that each level 2a-2f has a substantially flat surface on which the storage totes 4 are received. As shown, the grid is formed of rows 5 of tile units 3 aligned in the X direction, and columns 6 of tile units 4 aligned in the Y direction. If multiple levels 2 are provided the levels 2a-2f are arranged on top of each other in a Z direction. In examples, the levels 2a-2f are aligned and overlap, for example partially overlap or completely overlap.

As mentioned above, storage totes 4 are supported on the tile units 3. As shown, the shape of the storage totes 4 approximately matches the shape of the tile units 3 and the storage totes 4 are sized slightly smaller than the tile units 3 so that storage totes 4 on adjacent tile units 3 are not in contact with each other. The storage totes 4 may be open-topped plastic containers, and may have a standard size. For example, the storage totes 4 may be so-called Euro Containers having a standard size of 30 cm×20 cm or 80 cm×60 cm or 60 cm×40 cm.

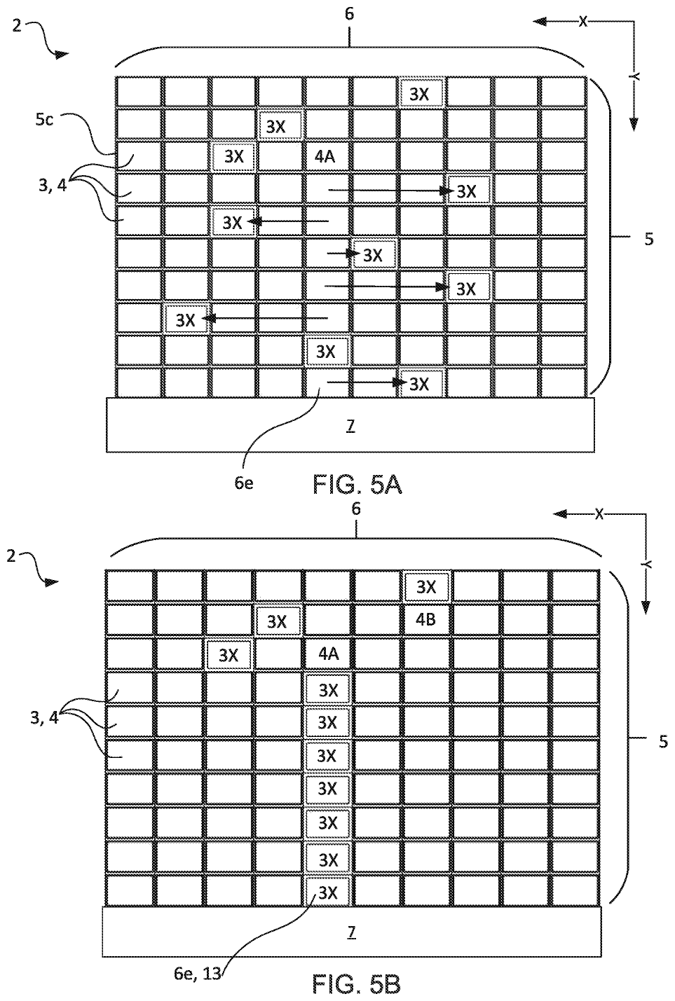

As described further below with reference to FIGS. 4 and 7A to 8B, each tile unit 3 has a drive means (drive unit) operable to move a storage tote 4 in either the X direction (along a row 5) or in the Y direction (along a column 6). A control system is provided to operate the tile units 3 to move the storage totes 4 in the X direction or the Y direction. Accordingly, the tile units 3 can be operated to move storage totes 4 along rows 5 and/or columns 6 to move storage totes 3 around the grid of tile units 3. In particular, as shown in FIG. 4, the tile unit 3a is operable to move a storage tote 4a to one of the tile units 3b or 3c in the X direction (along the row 5), or one of the tile units 3d or 3e in the Y direction (along the column 6).

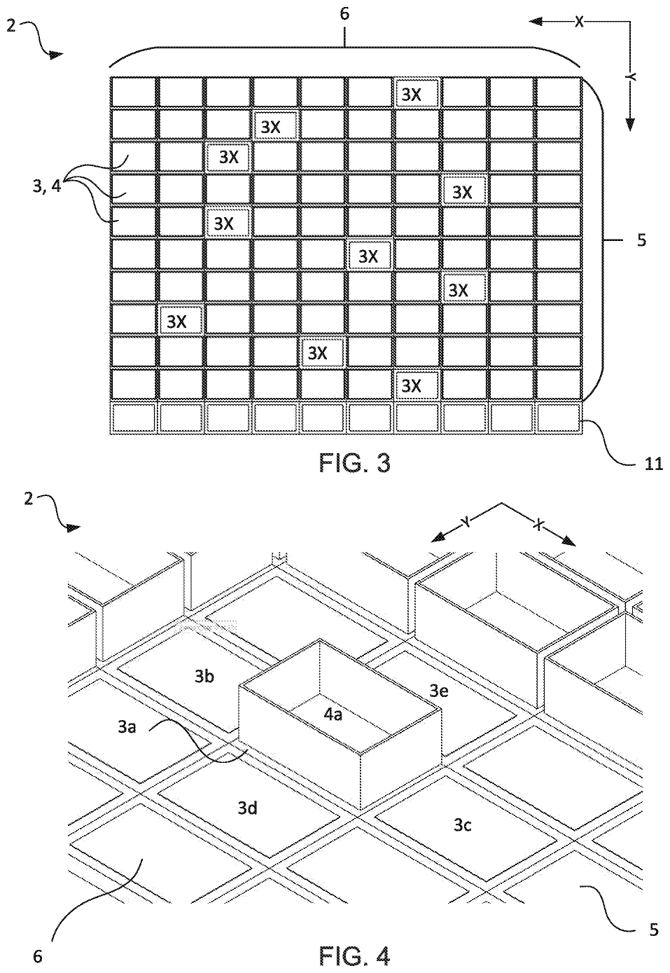

In preferred examples a majority of the tile units 3 hold a storage tote 4 to provide high storage density. Multiple tile units 3 can be simultaneously operated to simultaneously move several storage totes 4 move along a row 5 or column 6. Alternatively, tile units 3 may be operated in a successive manner to successively move storage totes 4 along a row 5 or column 6, with a first moving into an empty space, followed by the others. To permit movement of the storage totes 4 along the rows 5, at least one tile unit 3 in each row 5 is empty as shown in FIG. 3. That is, there is at least one tile unit 4 in each row 5 that does not hold a storage tote 4. In FIG. 3 empty tile units 3 are indicated by 3X. In the illustrated configuration each row 5 has one empty tile unit 3X. However, it will be appreciated that during operation, for example depending on removal and addition of storage totes 4, each row 5 may have more than one empty tile unit 3. Accordingly, tile units 3 can be operated to move storage totes 3 along the rows 5 to change the positions of the empty tile units 3X. In operation, to move a storage tote 4 in the Y direction the tile units 3 are operated to move the other storage totes 4 in such a way to align the empty tile units 3 and create an aisle in the Y direction for passage of the storage tote 4.

As shown in FIG. 1, an output station, in this example a pick station 7, is provided at the ends of the columns 6. The pick station 7 comprises a conveyor 8 at which an operator (or robot) can place goods into storage totes 4 and/or remove goods from storage totes 4, or move the storage totes 4 themselves into/out of the pick station 7. Accordingly, in this example the pick station 7 acts as an input station and as an output station for the goods. The conveyor 8 may comprise a roller conveyor 9 and/or one or more tile units 3 arranged in a row 11, as illustrated. The conveyor 8 is preferably around waist height, so that an operator can stand by the pick station 7 and easily reach and move items on the upper face of the pick station 7. In other examples, the output station may comprise a conveyor that conveys the storage totes 4 away from the automated storage and retrieval system 1. Such a conveyor may comprise a plurality of tile units 3 arranged in a line, or a conventional conveyor type such as a roller or belt conveyor.

Where the automated storage and retrieval system 1 comprises more than one level 2a-2f, as shown in FIG. 1, the pick station 7 may additionally comprise one or more lifts 10a, 10b for moving storage totes 4 in the Z direction, between levels 2a-2f. Storage totes 4 are moved along the first row 11 of tile units 3 to move from a level 2 onto one of the lifts 10a, 10b, or after being deposited in a level 2 by the lifts 10a, 10b.

In examples with only a single level 2 of tile units 3, no lifts 10a, 10b are needed and the first row 11 of tile units 3 may act as a pick station for an operator.

As also illustrated in FIG. 1, a rear row 12 of tile units 3 may also be empty, without storage totes 4. In some examples, a further pick station may be provided at the rear row 12 of tile units 3. In examples, one of the pick stations may be used to deposit goods (an input station), and the other used to retrieve goods (an output station). Alternatively, the rear row 12 of tile units 3 may also have storage totes 4 and only one pick station 7 may be provided. Alternatively, the rear row 12 of tile units 3 may be left empty and used to move storage totes 4 between different columns 6 at the rear of the automated storage and retrieval system 1.

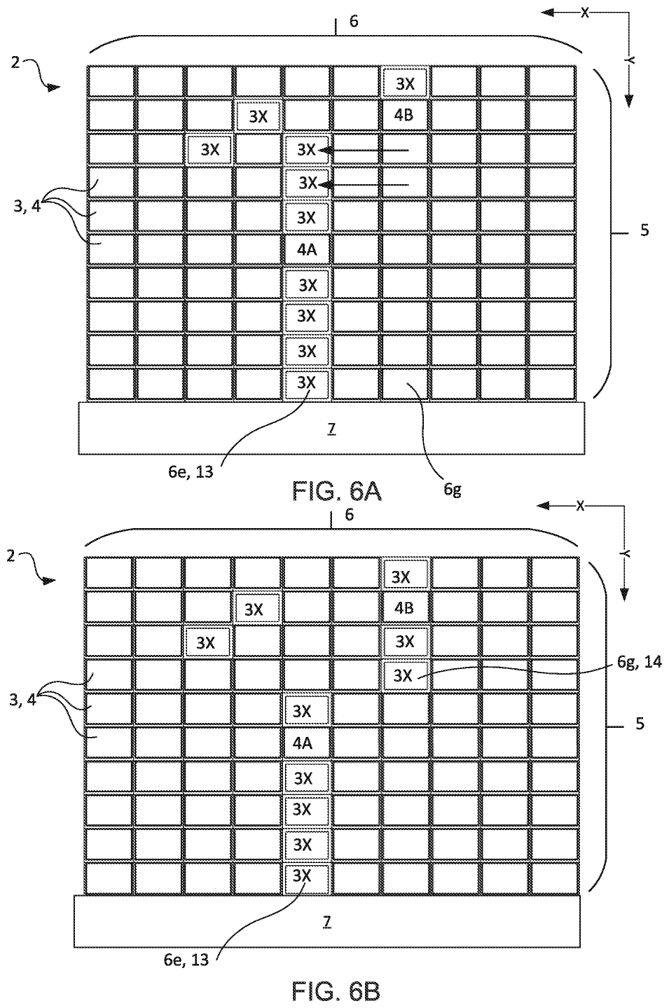

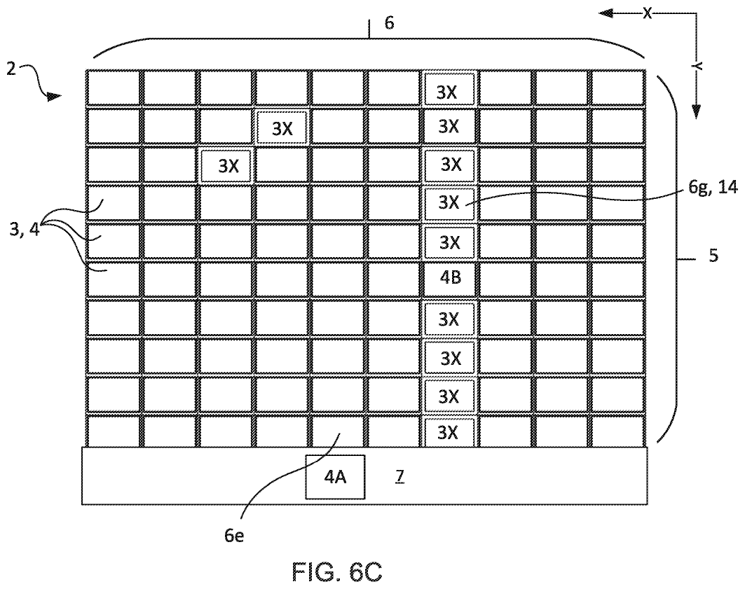

FIGS. 5A to 6C illustrate the formation of aisles 13, 14 within the grid of tile units 3 for movement of storage totes 4 in the Y direction, towards and away from the pick station 7. FIGS. 5A and 5B illustrate the formation of a single aisle, and FIG. 6A and 6C illustrate the simultaneous formation of two or more aisles.

FIGS. 5A and 5B illustrate an operation to bring storage tote 4A to the pick station 7. As shown in FIG. 5A, initially there is one empty tile unit 3 in each row 5. In order to create an aisle for the storage tote 4A, tile units 3 are operated to move the storage totes 4 in column 6e as indicated by the arrows. As explained above with reference to FIG. 4, multiple storage totes 4 in each row 5 can moved simultaneously, or successively, until the empty tile unit 3X is provided in column 6e. FIG. 5B shows the resulting aisle 13 of empty tile units 3X formed in column 6e, allowing the storage tote 4A to be moved to the pick station 7 along the aisle.

FIGS. 6A to 6C illustrate an example of forming a second aisle 14 for storage tote 4B, which is indicated in FIGS. 5B, 6A to 6C. In an initial state, shown in FIG. 5B, the storage tote 4B is called to the pick station 7 either before, during or after transit of the storage tote 4A along the initial aisle 13. In this example, storage tote 4A is first moved to the pick station 7, followed by storage tote 4B. As shown in FIG. 6A, once the storage tote 4A has moved beyond the corresponding row of the storage tote 4B, tile units 3 in column 6g are operated to move the storage totes 4 and create an aisle 14 in the column 6g corresponding to the storage tote 4B. In other words, the aisle 13 can be closed behind the storage tote 4A, allowing a second, offset aisle 14 to be created for passage of the storage tote 4B towards the pick station 7, as shown in FIG. 6B. FIG. 6C shows the completion of aisle 14 once the storage tote 4A has reached the pick station 7. As shown in FIG. 6C, the initial aisle 13 in column 6e has been closed in order to create space for the subsequent aisle 14.

It will be appreciated that multiple dynamic aisles 13, 14 can therefore be created to provide low latency retrieval of storage totes 4 from within the grid to the pick station 7. In particular, as the aisles 13, 14 are dynamic they need only have a length (in the Y direction) of two or three tile units 3 within which the called storage tote 4 moves. This allows multiple aisles to be created simultaneously, in different columns 6, so long as they are offset in the Y direction.

It will also be appreciated that the same concept may be used to create multiple aisles aligned in the Y direction (i.e., no offset as described above) if there is more than one empty tile unit 3 per row 5. For example, large installations may be divided into operational sub-units, each sub-unit having at least one empty tile unit 3 per row 5. Additionally, as storage totes 4 are retrieved from the grid they leave additional empty tile units 3 for at least a time until the storage tote 4 is returned to the grid. Accordingly, during operation it may be possible to create multiple aisles that are aligned in the Y direction.

In some examples, if more than one tile unit 3 in a row 5 is empty, the storage tote 4A, 4B may be moved into a different column 6 during transit to the pick station 7 (e.g., to avoid obstacles or to improve dynamic aisle creation). In such an example the aisle is formed in two different columns 6, or more than one storage tote 4 is conveyed through an aisle.

Once a storage tote 4 has reached the pick station 7 goods may be retrieved and/or deposited in the storage tote 4 and the storage tote 4 can be returned to the grid of tile units 3 in the same manner as it was retrieved—by creating an aisle along one of the columns 6. Alternatively, the storage tote 4 itself can be removed from the pick station 7, and optionally a different storage tote 4 can replace it.

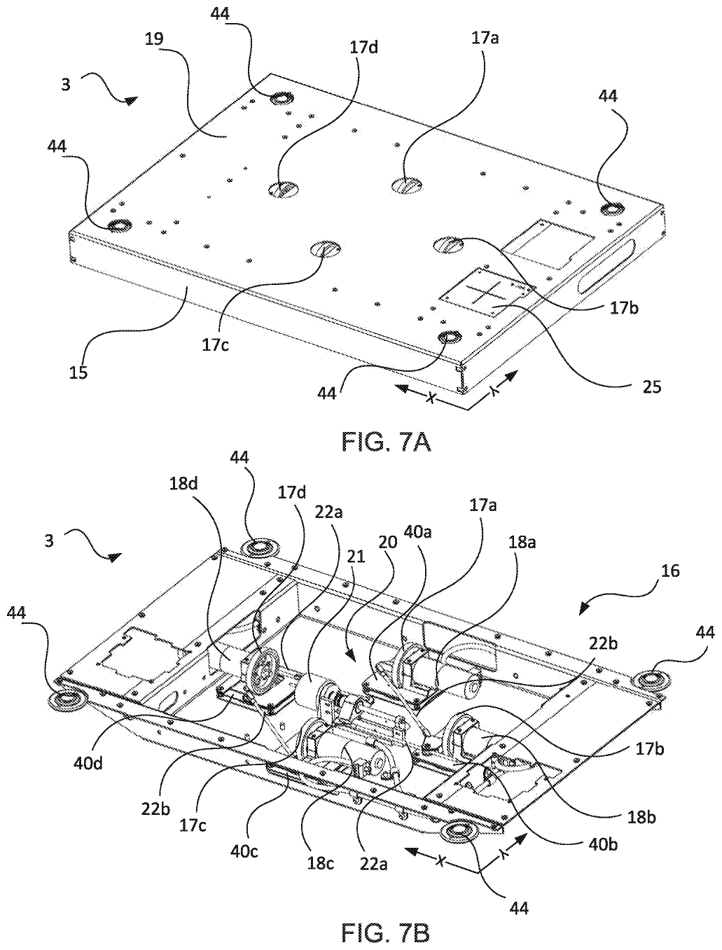

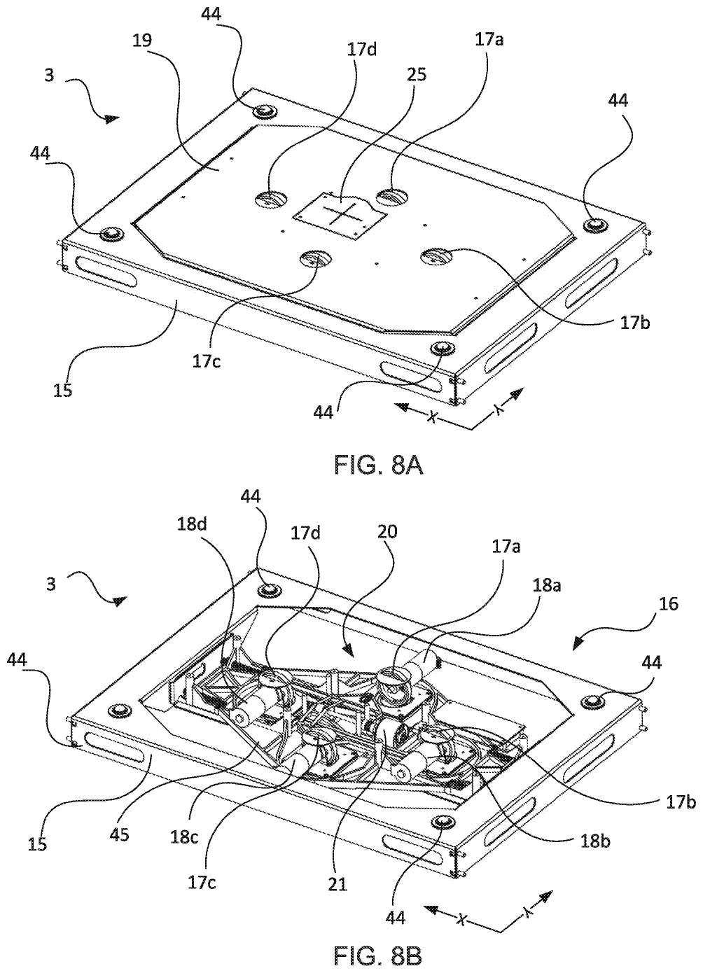

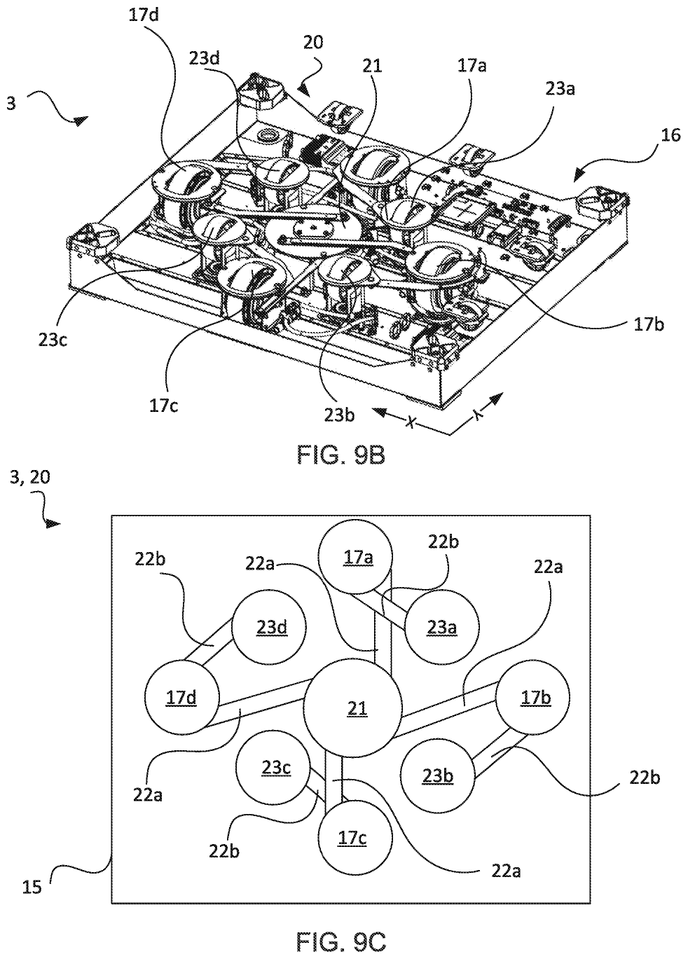

FIGS. 7A to 8B illustrate examples of the tile unit 3. As described below, each tile unit 3 has a drive unit 16 operable to move a storage tote 4 that is received on top of the tile unit 3. As described with reference to FIGS. 10A to 13, the drive unit 16 may directly engage and drive a storage tote 4, or it may engage and drive a skid plate 32 on which goods or the storage tote 4 is received.

The drive unit 16 has at least one directionally-adjustable drive, for example a drive wheel or drive belt, which engages the storage tote 4 and is driven to move the storage tote 4. The control system of the automated storage and retrieval system 1 controls each tile unit 3 to operate the drive unit 16 such that storage totes 4 can be moved in either the X direction (along a row of the grid) or in the Y direction (along a column of the grid) in the manner described above to retrieve and return storage totes 4 and to move storage totes 4 around the automated storage and retrieval system.

FIGS. 7A and 7B illustrate a first example tile unit 3 of the automated storage and retrieval system 1 illustrated in FIGS. 1 to 6C. As shown in FIG. 7A, the tile unit 3 has a housing 15. The housing 15 is generally quadrilateral, being rectangular as illustrated or square. The housing 15 has the general form of a shallow rectangular box with a planar, substantially closed upper surface. The housing 15 is a self-contained unit such that the automated storage and retrieval system 1 can be modular and easily adapted to different installation sites.

The top of the housing 15 is omitted from FIG. 7B for clarity. As shown in FIG. 7B, a drive unit 16 is housed within the housing 15. The drive unit 16 includes drive wheels 17, in this example four drive wheels 17a-17b. Each drive wheel 17a-17b has an associated drive motor unit 18a-18d for rotating the drive wheel 17a-17b. As shown in FIG. 7A, the drive wheels 17a-17d protrude through openings in the housing 15 and beyond a top surface 19 of the housing 15. Accordingly, when a storage tote is supported on the tile unit 3 the drive wheels 17a-17d are in contact with an underside of the storage tote. Rotation of the drive wheels 17a-17d by the drive motor units 18a-18d thereby moves the storage tote in the direction of rotation. In other examples, as described below, the drive wheels 17a-17d may engage a (skid) plate on which goods are directly received, or on which a storage container is received.

As shown in FIG. 7B, the drive unit 16 also includes a rotation mechanism 20 adapted to rotate (swivel) the drive wheels 17a-17d through ninety degrees about an axis normal (perpendicular) to the top surface 19 of the housing 15. The drive wheels 17a-17d are rotatably mounted to the housing 15 at pivots 40a-40d that permit the drive wheels 17a-17d to rotate to change orientation. The rotation mechanism 20 has an actuator 21 (a rotation motor) that is operable to move linkages 22 connected to each drive wheel 17a-17d to rotate the drive wheels 17a-17d. The actuator 21 is located approximately in the centre of the housing 15. In this embodiment, the actuation mechanism 21 is a ‘windscreen-wiper’-style motor, or similar. The actuator 21 may rotate in a single direction and cause the drive wheels 17a-17d to rotate, or the actuator 21 may rotate in different directions and cause the drive wheels 17a-17d to rotate. The actuator 21 is connected to some, but not all of, the drive wheels 17a-17d. In this embodiment, the actuator 21 is connected to two of the drive wheels 17b, 17d by first linkages 22a, and those drive wheels 17b, 17d are connected to the other drive wheels 17a, 17c by second linkages 21b. In this example the actuator 21 comprises a linear actuator (lead screw) that is operable to move an end point of the first linkages 21a to rotate the drive wheels 17a-17d. Accordingly, the drive wheels 17a-17d can be rotated to different orientations, for moving a storage tote in the X direction or in the Y direction.

As also shown in FIGS. 7A and 7B, the tile unit 3 includes roller ball guides 44 arranged to protrude beyond the top surface 19 and engage the storage tote or skid plate. The roller ball guides 44 comprise a ball and a seat so that the ball can rotate in any direction. In this example, four roller ball guides 44 are provided, one in each corner of the tile unit 3. As explained further below, roller ball guides 44 engage grooves on the underside of the storage tote or skid plate and help to align the storage tote or skid plate with the tile unit 3 and prevent misalignments that may be caused when storage totes or skid plates are moved from one tile unit 3 to another.

FIGS. 8A to 8C illustrate a second example tile unit 3 of the automated storage and retrieval system 1 illustrated in FIGS. 1 to 6C. The tile unit 3 of FIG. 8 is similar to that of FIGS. 7A and 7B in that it has a housing 15 and a drive unit 16 located within the housing 15.

In this example, the drive unit 16 comprises four drive wheels 17a-17d as per the example of FIGS. 7A and 7B. The tile unit 3 also includes roller ball guides 44 as described with reference to FIGS. 7A and 7B.

The rotation mechanism 20 of the example of FIGS. 8A to 8C is similar to that of FIGS. 7A and 7B and is operable to rotate the drive wheels 17a-17d about axes extending normal (perpendicular) to the top surface 19 of the housing as previously described. In particular, each drive wheel 17a-17d is mounted on a pivot 40a-40d and includes a motor 18a-18d. In this example the rotation mechanism 20, shown most clearly in FIG. 8C, has an actuator 21 (motor) that is coupled to an actuator plate 45 at a lead nut 47 so that rotation of the actuator 21 drives a linear movement of the actuator plate 45 (left-right as illustrated). The actuator plate 45 is coupled to each pivot 40a-40d at slots 46a-46d so that the linear movement of the actuator plate 45 rotates each pivot 40a-40d (and drive wheel 17a-17d) about an axis normal to the top surface 19. In this way, the actuator 21 can be used to rotate (swivel) the drive wheels 17a-17d between perpendicular positions for driving a storage tote or skid plate to an adjacent tile unit as described above.

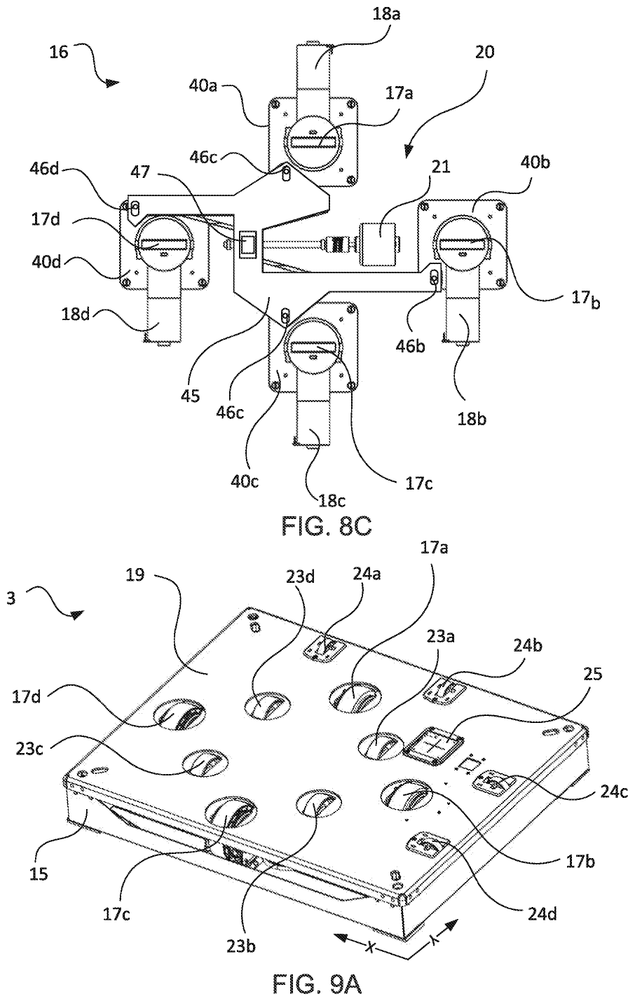

FIGS. 9A to 9C illustrate a third example tile unit 3 of the automated storage and retrieval system 1 illustrated in FIGS. 1 to 6C. The tile unit 3 of FIGS. 9A to 9C is similar to those of FIGS. 7A to 8C in that it has a housing 15 and a drive unit 16 located within the housing 15.

In this example, the drive unit 16 comprises four drive wheels 17a-17d as per the examples of FIGS. 7A to 8C, and additionally comprises guide wheels 23a-23d. The guide wheels 23a-23d protrude beyond the top surface 19 of the housing 15 like the drive wheels 17a-17d, but are not driven (there is no motor that drives the guide wheels 23a-23d). The guide wheels 23a-23d provide additional support for the storage tote.

The rotation mechanism 20 of the example of FIGS. 9A and 9B is similar to that of FIGS. 7A and 7B and is operable to rotate the drive wheels 17a-17d and the guide wheels 23a-23d about axes extending normal to the top surface 19 of the housing as previously described. The rotation mechanism 20, shown more clearly in FIG. 9C, has an actuator 21 and linkages 22a to rotate the drive wheels 17a-17d, and additional linkages 22b provided to connect between the drive wheels 17a-17d and the guide wheels 23a-23d. In particular, the drive wheels 17a-17d are connected to the actuator 21 by linkages 22a, and the guide wheels 23a-23d are connected to the drive wheels 17a-17d via linkages 22b. Each drive wheel 17a-17d is therefore paired with a guide wheel 23a-23d. In this way, rotation of the drive wheels 17a-17d also rotates the guide wheels 23a-23d. In this example the actuator 21 is a motor arranged to rotate a plate to which the linkages 22a, 22b are pivotally connected.

In the example shown in FIG. 9C, rotation mechanism 20 does not rotate all of the guide wheels 23a-23d in the same direction. As shown, the linkages 22b are arranged such that guide wheels 23a and 23c will rotate in the opposite direction to guide wheels 23b and 23d. In this way, the net effect on a storage tote located on top of the tile unit 3 is as neutral as possible.

In the example of FIGS. 9A and 9B, the tile unit 3 has four drive wheels 17a-17d, with the top part of each drive wheel 17a-17d protruding through apertures in the housing 15. The drive wheels 17a-17d are arranged so that in plan view/from above they are in a square formation, aligned so that the side of the square is rotated at substantially 45-degrees to the alignment of the side edges of the housing 15. The square is offset towards two edges of the housing 15, so two corners of the hollow square are at or close to the edges of the housing 15 and the other two are spaced from the edges of the housing 15. The guide wheels 23a-23d are arranged in the sides of the square, with one guide wheel 23a-23d disposed on each side of the square, between two drive wheels 17a-17d.

In an alternative example the rotation mechanism 20 illustrated in FIG. 9C may be used to rotate the drive wheels 17a-17d of the example tile units 3 of FIGS. 7A to 8C, but without the guide wheels 23a-23d and corresponding linkages 22b.

As shown in FIGS. 9A and 9B, additional rollers 24a-24d are also provided that protrude beyond the top surface 19 of the housing 15. The additional rollers 24a-24d are not driven and do not swivel. The additional rollers 24a-24d help to convey and/or align storage totes or skid plates as they move from the illustrated tile unit 3 to an adjacent tile unit.

As also shown in FIGS. 7A, 8A and 9A, each tile unit 3 comprises a sensor 25 provided on the top surface 19 of the housing 15. The sensor 25 is arranged to detect a presence/movement of a storage tote or skid plate, and/or to read an identity of a storage tote or skid plate on the tile unit 3. The sensor 25 is positioned on the tile unit 3, in particular on the top surface 19 of the housing 15, so as to ‘read’ upwards. In one example, the sensor 25 comprises a resonant inductive sensor to sense movement of a storage tote or skid plate over and across the sensor 25. In other examples, the sensor 25 could be an optical sensor or similar. The sensor 25 will trigger when a storage tote or skid plate moves over it, and off it. In other examples, the sensor 25 may comprise an RFID receiver or barcode scanner that reads a corresponding feature (RFID tag or barcode) on the storage tote or skid plate to identify the storage tote or skid plate.

The control system of the automated storage and retrieval system 1 knows the location of each tile unit 3 within the grid, and may track the location of each storage tote or skid plate using sensor signals from the various sensors 25 of the tile units 3. Information received from the sensors 25 may additionally or alternatively be used to confirm that storage totes or skid plate have moved from one tile unit 3 to another as instructed by the control system (i.e., to verify operation of the drive units 16).

FIGS. 10A and 10B illustrate a small grid of tile units 3, or a portion of a larger grid of tile units 3. In this example the tile units 3 are those illustrated in FIGS. 8A and 8B, but other example tile units 3 could be used instead. As shown, the tile units 3 are aligned in the X direction (i.e., in rows) and in the Y direction (i.e., in columns). As shown, the framework 30 includes a seat 31 for each tile unit 3. Each seat 31 is adapted to receive and support a tile unit 3. In examples, the tile units 3 are insertable into the seats 31 from above, i.e., from the Z direction. In this way, tile units 3 can be assembled into the automated storage and retrieval system 1 by lowering them into the seats 31 of the framework 30, and can be lifted out of the seats 31 for removal from the automated storage and retrieval system 1. This may allow tile units 3 to be retrieved from the automated storage and retrieval system 1 without having to remove any other components.

As shown, in this example the tile units 3 are arranged with no or very little space between them, for example abutting each other along the sides of the housings 15. In other examples, the framework 30 may separate the tile units 3 from each other by a small distance.

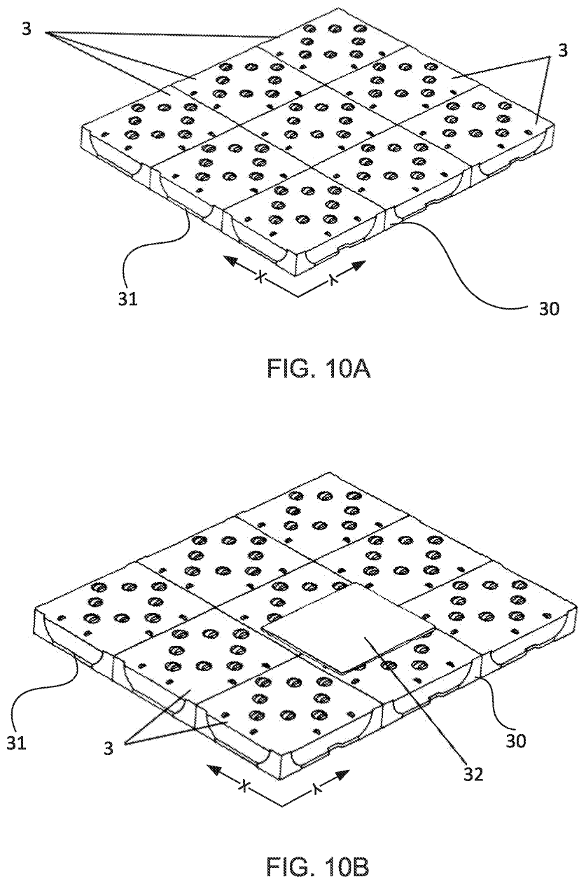

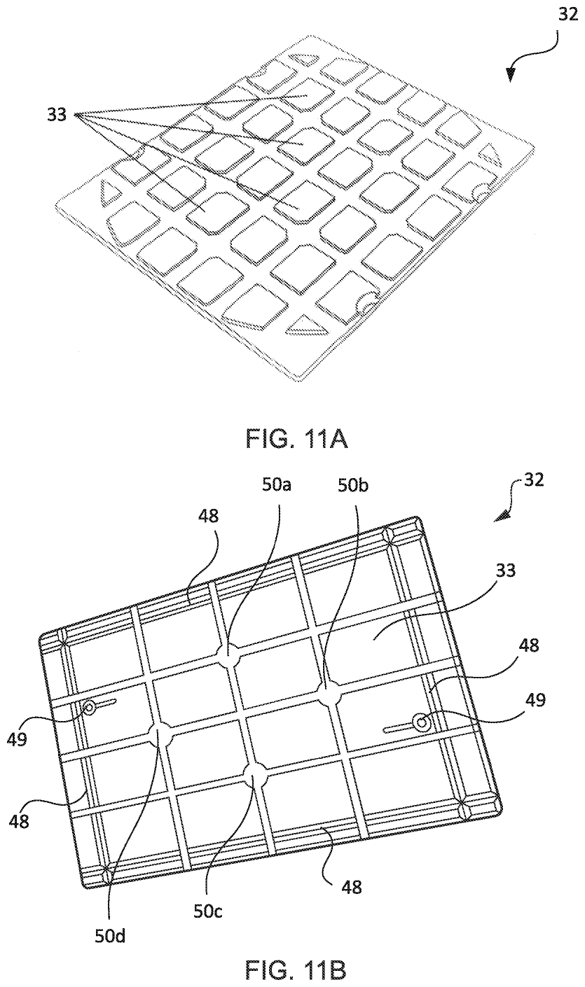

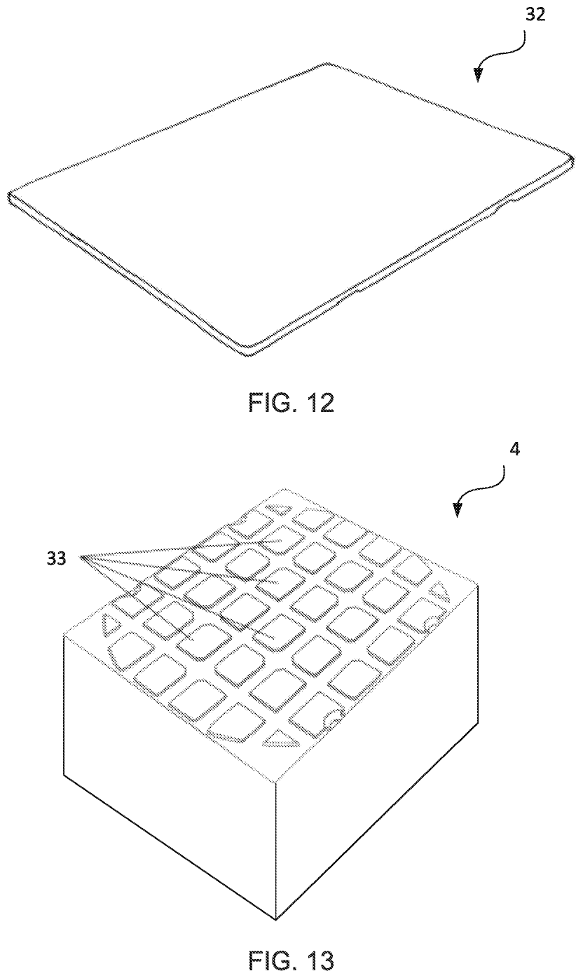

As explained below with reference to FIGS. 11 to 13, in some examples the storage totes 4 are received directly on the tile units 3. A storage tote 4 suitable for this is shown in FIG. 13 and described below. In other examples, a skid plate 32, such as that shown in FIG. 10B and FIG. 12, is received on a tile unit 3 and the goods, which may be in a storage container such as a storage tote 4, are carried on top of the skid plate 32.

In the example of skid plates 32, the skid plates 32 are positioned on top of the tile units 3 and the skid plates 32 and tile units 3 are mutually configured so that the skid plates 32 move on top of the tile units 3 in use. Each skid plate 32 has a profile similar to or slightly smaller than that of the tile unit 3.

The skid plates 32 are loaded with a storage tote 4 or similar container, or goods are received directly on the skid plates 32. The storage tote 4 has a plan profile roughly the same as or slightly smaller than that of the skid plate 5, and may have a height of 30 cm (or 50 cm in some embodiments). Each skid plate 32 is a flat plate formed from a robust material so that it will not easily bend or break in use.

In examples, the lower surface of the skid plate 32 or the lower surface of the storage tote 4, whichever is in contact with the tile unit 3 in use, comprises a number of wheel guides 33 as shown in FIGS. 11A and 11B. The profile of wheel guides 33 shown in FIG. 11A and FIG. 11B may be provided on either the underside of the skid plates 32, or on the underside of the storage tote 4 in the example without skid plates 32.

In the example of FIG. 11A, the wheel guides 33 are arranged in the shape of crosses. The wheel guides 33 act to keep the skid plate 32 or storage tote 4 aligned with the required axis of movement when it first moves off/away from a tile unit 3 on which it is located, and to compensate for any offset in the wheel or power differential from the motors that might cause the skid plate 32 or storage tote 4 to become misaligned and to move in slightly the wrong direction or at the wrong angle when moved by the tile unit 3. The wheel guides 33 and drive wheels 17a-17d (see FIGS. 7A-8B) are sized and shaped so that the drive wheels 17a-17d can freely rotate within the centre of the cross formed by the wheel guides 33.

In the example of FIG. 11B, the skid plate 32 includes wheel guides 33 arranged in crosses that align with the wheels when the skid plate 32 is moving onto or off a tile unit. Additionally, the skid plate 32 includes swivel recesses 50a-50d that are aligned with the wheels of a tile unit when the skid plate 32 is centrally located on the tile unit. The swivel recesses 50a-50d permit the wheels to be rotated to different orientations. Additionally, the skid plate 32 of FIG. 11B includes four rounded grooves 48, which each have a rounded, for example semi-circular, cross-section. The rounded grooves 48 are arranged to align with, and be engaged by, the roller ball guides 44 illustrated in FIGS. 7A and 8A. The roller ball guides 44 and rounded grooves 48 cooperate to ensure alignment between the skid plate 32 and the tile unit 3.

As also shown in FIG. 11B, the skid plate 32 includes one or more sensor elements 49, in this example two sensor elements 49. The illustrated sensor elements 49 are passive RFID coils that can be read by the sensors 25 on the tile units 3 shown in FIGS. 7A, 8A, and 9A. In other examples, the sensor elements 49 may be a code, for example a bar code or QR code or similar for scanning. The sensor elements 49 and sensors 25 allow the tile units 3 to identify the skid plate 32 or storage tote arriving at, present on, or leaving, and that information may be used to track and/or verify the locations and movements of skid plates 32 and storage totes.

As outlined above, the tile units 3 are all the same shape and size, and are laid out in a continuous grid pattern, side-by-side with one another, so that the corners of directly adjacent tiles are proximate or coincident.

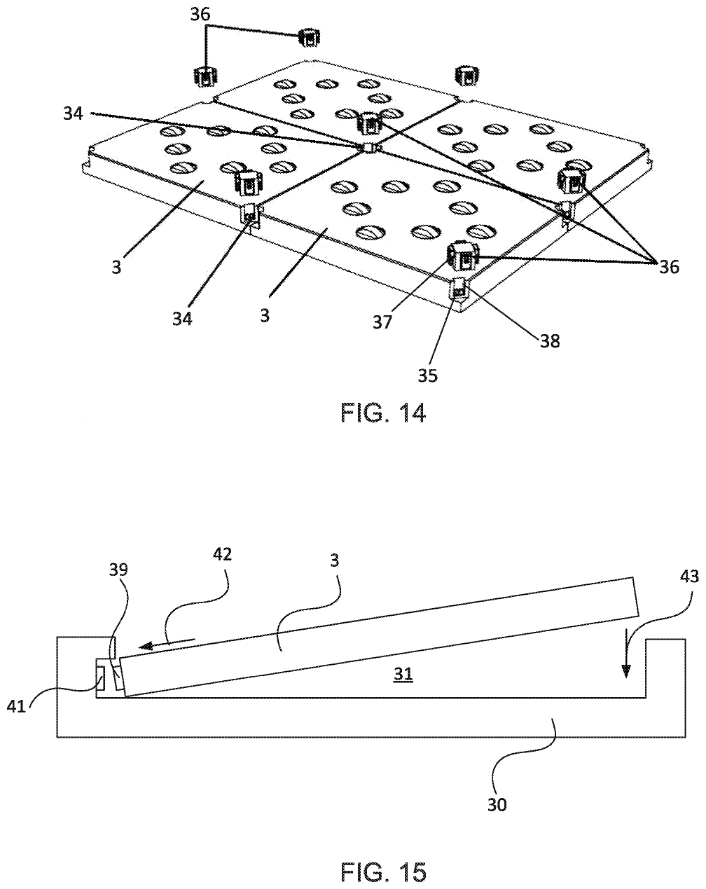

As shown in FIG. 14, the tile units 4 may have a cut-out 38 at each corner, so that an aperture or socket 34 is formed at the mutually intersecting corners of any two or more (e.g., four) tile units 3 arranged adjacent to one another in the grid. As shown in FIG. 14, each cut-out 38 has an electronic socket connection 35 located within the cut-out 38, so that there are multiple electronic socket connections 35 formed within each socket 34 when a grid is formed.

In use, an interconnection and communication element or plug 36 locates into each socket 34. The plugs 36 comprise electronic socket connections 37 corresponding to the electronic socket connections 35 formed in the cut-outs 38 of the tile units 3, such that adjacent tile units can electronically connected for communication and power transmission between the tile units 3. This also facilitates connection to a central power source and/or controller that can be connected to just one (or more) tile units 3 of the grid, for example at an edge of the grid.

In alternative examples, the plugs 36 may be integrated into the framework that supports the tile units 3. The cut-outs 38 in the tile units 3 may be arranged on a bottom side of the tile units 3, with the electronic socket connections 35 directed downwards, and the electronic socket connections 37 of the plugs 36 may be directed upwards. In this way, the electronic socket connections 35 and electronic socket connections 37 are connected when a tile unit 3 is assembled into the framework. This arrangement also beneficially allows tile units 3 to be lifted from the grid without first having to remove the separate plugs 36 shown in FIG. 14. Power and communication connections can be routed through the framework to one or more of the integrated plugs 36, and can be distributed through the grid of tile units 3 via the tile units 36 themselves.

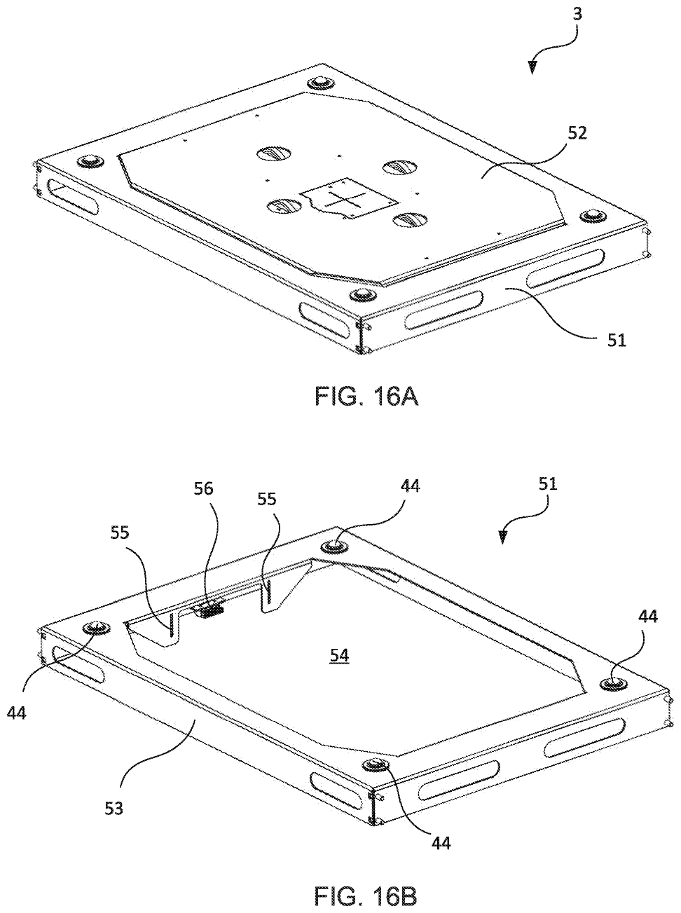

In the example of FIG. 15, the tile unit 3 is slid into the seat 31 formed in the framework 30. The tile unit 3 comprises an electrical socket connection 39 formed on a side of the tile unit 3, which is arranged to connect with a corresponding electrical socket connection 41 formed in the seat 31 or framework 30 when the tile unit 3 is slid substantially sideways into the seat 31 in the direction of arrow 42. The tile unit 3 may then be rotated in the direction of arrow 43 to be fully received in the seat 31. Accordingly, the tile unit 3 can be assembled into the seat 31 and an electrical connection formed via the electrical socket connections 39, 41. In this example, the tile unit 3 can be removed from the seat 31 (and grid) by lifting, rotating and sliding the tile unit 3 out of the seat 31, allowing the tile unit 3 to be removed without having to remove other components or fasteners.

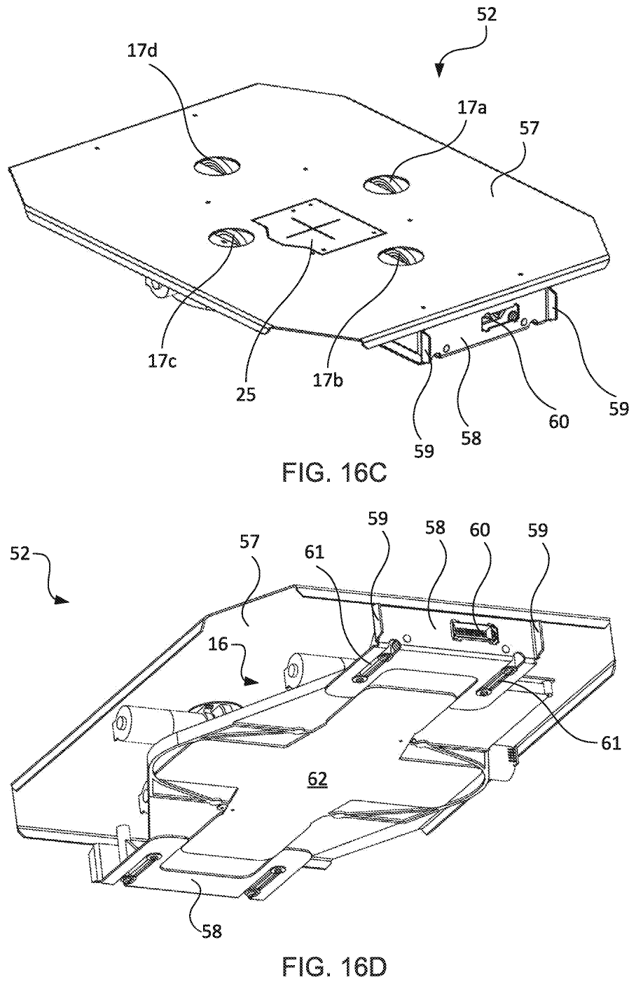

FIGS. 16A to 16D illustrate a further example tile unit 3 that includes a seat 51 and a removable section 52. FIG. 16A shows the complete, assembled tile unit 3, FIG. 16B shows the seat 51 in isolation, and FIGS. 16C and 16D show the removable section 52 from different angles. The tile unit 3 illustrated in this example is the same as the tile unit 3 described with reference to FIGS. 8A to 8C, but it will be appreciated that the other tile units 3 may have a similar arrangement with a seat and a removable section. As illustrated, the seat 51 comprises a frame 53 with an opening 54 for receiving the removable section 52. The frame 53 also includes the roller ball guides 44 as described with reference to FIGS. 7A to 8C. Latch openings 55 are provided at opposite ends of the frame 53 for attaching the removable section 52. In the illustrated example, there are two latch openings 55 formed at each end of the frame 53, with only one end being visible. One end of the frame 53 also includes an electrical plug 56 for forming an electrical connection between the seat 51 and the removable section 52. The electrical plug 56 is connected with a circuit board mounted on the frame 53. The circuit board includes one or more ports for power and/or communications connections with other tile units and/or a central controller of the automated storage and retrieval system 1. The circuit board may also include a memory storing identity and/or address information for the tile unit 3.

As shown in FIGS. 16C and 16D, the removable section 52 includes a top plate 57 and the drive unit 16 of the tile unit 3, which includes the drive wheels 17a-17d and associated motors and rotating mechanism as previously described. These are mounted to a chassis 62. The chassis 62 and top plate 57 may be the same component or attached to each other. At opposite ends of the removable section 52 a sliding latch 58 is provided. The sliding latch 58 is slidably mounted to the chassis 62 via slots 61. A spring (not shown) may be arranged to urge the sliding latches 58 in an outward direction. Each sliding latch 58 includes latch members 59 that correspond to the latch openings 55 in the frame 53 as shown in FIG. 16B. One of sliding latches 58 also includes an electrical socket 60 that aligns with, and connects to, the electrical plug 56 on the frame 53.

In some examples, the sliding latch is not spring-biased, and may instead clip or click into engagement with the latch openings 55. The sliding latch 58 provides a fastener-less attachment between the removable section 52 and the seat 51.

To assemble the removable section 52 and the seat 51, the two sliding latches 58 are pushed inwardly, towards each other, the removable section 52 can then be moved into the opening 54 in the frame 53 (either from above or from below), and the sliding latches 58 can be allowed to slide outwardly, away from each other, so that the latch members 59 engage the latch openings 55. At the same time, the electrical plug 56 and the electrical socket 60 engage to form an electrical connection. The electrical connection provides power to the drive unit 16 and may also include a communications connection.

Accordingly, the removable section 52 can be removed from, or inserted into, the seat 51 without having to remove the seat 51 from the frame and other arrangements that form the matrix of tile units 3 as previously described. Advantageously, this simplifies assembly of the automated storage and retrieval system 1 because the frame can be assembled with the seats 51 to form the matrix, and then the removable sections 52 can be assembled into the matrix. Additionally, the removable units 52 include all of the mechanical parts of the tile unit 3, so it can be expected that any mechanical failure would occur within a removable section 52, which can then be removed and replaced without disturbing the frame.

In some examples, a robotic device may be provided for moving across the tile units of a matrix and has arms for removing/inserting removable sections 52. Thus, the robotic device can be used to retrieve and replace the removable sections 52 of faulty tile units 3 within the matrix. The robotic device may remove/insert a removable section 52 from below or from above.

In some examples, each tile unit 3 contains one or more of various elements, such as for example a wireless transmitter, a power distribution node, a communication distribution system (e.g. location aware V1 CANBUS; UWB/BLE); a power distribution system; a localised safety distribution system (RFID; UWB/BLE), and; an RFID reader.

It can be seen that each individual tile unit 3 in the grid therefore acts as a link in the overall network. Each tile unit 3 can establish its position relative to the other tile units 3. This helps to minimise infrastructure requirements, and also allows tile units to be swapped out and the grid reconfigured as required. Each tile unit 3 may be ‘plug and play’, and may not need to be configured individually into a unique grid layout. Tile units 3 can be ‘hot swapped’ without need to take the grid offline, or for each new tile unit 3 (and existing tile units 3 within the grid) to be configured for the new arrangement. The automated storage and retrieval system 1 can also continue to work around a missing or malfunctioning tile unit 3.

At least some and preferably all of the tile units 3 are configured so that they can communicate with a central control system. The control system provides instructions to the tile units 3, and receives status updates and similar information back from the tile units 3 in return. In examples, the tile units 3 are also configured so that they can communicate directly with other tile units 3—at least the tile units 3 directly adjacent to themselves. This allows them to co-ordinate their actions with each other directly.

Items on top of the grid—the storage totes 4 or skid plates 32—are moved around the grid through the cooperation of multiple tile units 3 working in a coordinated manner to route items from one tile unit 3 to another, so that in overall operation items are moved from a source to a destination.

The control system may ‘know’ where each tile unit 3 is within the overall grid, and from this, which tile units 3 any particular individual tile unit 3 is physically adjacent to. The control system may ‘know’ what each tile unit 3 is doing/what action the tile unit 3 is undertaking at any particular time. The control system may use this information to send instructions to a tile unit 3, so that the tile unit 3 carries out the correct action at the correct time—e.g. moving an item across its surface in a particular direction.

As outlined above, the tile units 3 are arranged into a grid, with CAN Bus connections made through the plugs 36. Suitable identification signals can be sent through each of these connections—a first ‘row’ CAN ID for the row CAN bus and a second ‘column’ CAN ID for the column CAN bus). These IDs can be treated in a similar manner to ‘X’ and ‘Y’ co-ordinates so that an individual tile unit 3 can calculate its own location/address within the network.

In some examples, each tile unit 3 comprises a communications unit that is connected to a server to form a point-to-point network. The network allows the tile units 3 to communicate with the server and/or with other tile units 3. Each tile unit 3 has a unique address within the network. The address may include X-Y-Z coordinates. Tile units 3 may communicate with the server to send sensor information and/or to receive instructions for operating the drive unit, or may directly communicate with other tile units 3 in the grid for the same reasons. Adjacent tile units 3 may be operated together to move a goods transport means from one tile unit 3 to another. In some examples the communications unit may include a communications port for a wired communications connection, for example an ethernet port, for communications between the tile units and/or the server. In other examples, the communications unit may include a wireless communications unit for wireless communications between the tile units and the server, and/or directly between tile units. In some examples, the tile units may include a wired communications connection (e.g., an ethernet port) connecting the tile units to a wireless communications hub located within the automated storage and retrieval system. Therefore, a network may be formed of a combination of wired and wireless communications allowing tile units to communication with each other and/or with the control system.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An automated storage and retrieval system for storing goods within a storage and order processing facility, the automated storage and retrieval system comprising:
a framework, configured to form at least part of a multi-level matrix comprising a plurality of vertically-stacked levels;
a plurality of tile units, configured so as to in use form a grid on each level, each grid comprising a substantially continuous substantially planar upper surface;
a plurality of goods transport means configured to locate onto and move across the substantially continuous substantially planar upper surfaces of the grids;
the tile units further comprising a drive means configured to move the goods transport means on top of the grids; and
a control system configured to adjust the drive means to alter the position of the goods transport means on the grid.

2. The automated storage and retrieval system of claim 1, further comprising at least one lift means configured to move the goods transport means between levels.

3. The automated storage and retrieval system of claim 1, wherein the levels are at least partly overlapping.

4. The automated storage and retrieval system of claim 3, wherein the levels are substantially the same size and substantially fully overlapping.

5. The automated storage and retrieval system of claim 1, comprising an output station.

6. The automated storage and retrieval system of claim 5, wherein the output station comprises a pick station.

7. The automated storage and retrieval system of claim 5, wherein the output station comprises a conveyor.

8. The automated storage and retrieval system of claim 7, wherein the conveyor comprises a plurality of tile units arranged in a line.

9. The automated storage and retrieval system of claim 5, wherein the lift means is arranged to align with the output station in one position.

10. The automated storage and retrieval system of claim 1, further comprising an input station.

11. The automated storage and retrieval system of claim 1, wherein the drive means comprises a drive wheel arranged to engage an underside of the goods transport means and rotate to move the goods transport means.

12. The automated storage and retrieval system of claim 11, wherein the drive wheel is rotatable about an axis perpendicular to the substantially planar upper surface of the tile unit such that the drive wheel can be rotated for moving the goods transport means in different directions.

13. The automated storage and retrieval system of claim 12, wherein the drive wheel is rotatable about the axis perpendicular to the substantially planar upper surface by 90 degrees.

14. The automated storage and retrieval system of claim 11, wherein the goods transport means comprises wheel guides arranged to align with the drive wheel when the goods transport means is moving relative to the tile unit.

15. The automated storage and retrieval system of claim 14, wherein the goods transport means comprises a swivel recess arranged to align with the drive wheel when the goods transport means is aligned with the tile unit, the swivel recess being arranged to permit rotation of the drive wheel about the axis normal to the substantially planar upper surface of the tile unit.

16. The automated storage and retrieval system of claim 1, wherein each tile unit further comprises a guide roller, wherein each goods transport means comprises a groove, and wherein the guide roller engages the groove in the goods transport means to maintain alignment between the tile unit and the goods transport means during movement of the goods transport means.

17. The automated storage and retrieval system of claim 16, wherein the guide roller is a roller ball guide, and wherein the groove in the goods transport means is rounded.

18. The automated storage and retrieval system of claim 1, wherein each tile unit comprises a seat and a removable section, the removable section comprising the drive means.

19. The automated storage and retrieval system of claim 18, wherein the removable section is attachable to the seat by a latch.

20. The automated storage and retrieval system of claim 17, wherein the removable section is attachable to the seat in a fastener-less manner.

21. The automated storage and retrieval system of claim 18, wherein the seat comprises an electrical connector, and wherein the removable section comprises a corresponding electrical connector to connect with the electrical connector of the seat when the removable section is attached to the seat.

22. The automated storage and retrieval system of claim 18, wherein the seat comprises a circuit board having a port for power and/or communications connections.

23. The automated storage and retrieval system of 22, wherein each tile unit is connected to an adjacent tile unit and/or to a control system via the port.

24. The automated storage and retrieval system of claim 22, wherein the circuit board comprises a memory storing address information for the tile unit.

25. The automated storage and retrieval system of claim 1, wherein the goods transport means comprises a container.

26. The automated storage and retrieval system of claim 1, wherein the goods transport means comprises a plate on which a container or goods can be carried.

27. The automated storage and retrieval system of claim 1, wherein at least some of the plurality of tile units comprises a sensor, and wherein each goods transport means comprises a sensor element that is detectable by the sensor.

28. An automated storage and retrieval system for an order processing facility containing goods held on goods transport means, the automated goods storage and retrieval system comprising:
a plurality of tile units arranged in a grid having rows and columns, each tile unit being adapted to support a goods transport means and comprising a drive unit operable to move the goods transport means to an adjacent tile unit in a row direction or in a column direction,
an output station for removing goods from the automated storage and retrieval system, the output station being positioned at an end of at least one of the columns of the grid, and
a control system configured to track the positions of the goods transport means within the grid and to control the drive units of the tile units to move the goods transport means to the output station for retrieval of goods, wherein the control system is configured to move a called goods transport means from a tile unit in the grid to the output station by:
moving goods transport means in a column corresponding to the called goods transport means in the row direction to create an aisle in the column direction, and
moving the called goods transport means along the aisle to the output station.

29. The automated goods storage and retrieval system of claim 28, wherein the control system is configured to simultaneously move a plurality of goods transport means in a row in the row direction.

30. The automated goods storage and retrieval system of claim 28, wherein the control system is configured to successively move a plurality of goods transport means in a row in the row direction.

31. The automated goods storage and retrieval system of claim 28, wherein the aisle has a minimum length of at least two tile units in the column direction, for example a minimum length of at least three tile units in the column direction.

32. The automated goods storage and retrieval system of claim 28, wherein, during movement of the called goods transport means along the aisle the control system is configured to move goods transport means in the row direction to close the aisle behind the called goods transport means.

33. The automated goods storage and retrieval system of claim 28, wherein the control system is configured to move a second called goods transport means from a tile unit in the grid to the output station by:
when the called goods transport means has passed by the row corresponding to the second called goods transport means, moving goods transport means in a column corresponding to the second called goods transport means in the row direction to create a second aisle in the column direction for the second called goods transport means, and
moving the second called goods transport means along the second aisle to the output station.

34. The automated goods storage and retrieval system of claim 28, wherein, at a maximum storage density, one tile unit in each row is empty.

35. The automated goods storage and retrieval system of claim 28, wherein the automated goods storage and retrieval system comprises a plurality of levels arranged on top of each other, each level having a plurality of tile units arranged in a grid.

36. The automated goods storage and retrieval system of claim 35, further comprising at least one lift arranged to move goods transport means between levels and/or between a level and the output station.

37. The automated goods storage and retrieval system of claim 36, comprising a first lift arranged to move goods transport means from a level into the output station, and a second lift arranged to move goods transport means from the output station onto a level.

38. The automated goods storage and retrieval system of claim 28, wherein the output station comprises a conveyor along which goods transport means are conveyed.

39. The automated goods storage and retrieval system of claim 38, wherein the conveyor comprises a plurality of tile units, each tile unit having a drive unit operable to move the goods transport means to an adjacent tile unit in the conveyor.

40. A method of operating an automated storage and retrieval system for an order processing facility containing goods held on goods transport means, the automated storage and retrieval system comprising a plurality of tile units arranged in a grid having rows and columns, each tile unit being adapted to support a goods transport means and comprising a drive unit operable to move the goods transport means to an adjacent tile unit in a row direction or in a column direction, and an output station for removing goods from the goods transport means, the output station being positioned at an end of at least one of the columns of the grid,
wherein the method comprises moving a called goods transport means from a tile unit in the grid to the output station by:
moving goods transport means in a column corresponding to the called goods transport means in the row direction to create an aisle in the column direction, and
moving the called goods transport means along the aisle to the output station.

41. The method of claim 40, comprising simultaneously moving a plurality of goods transport means in a row in the row direction.

42. The method of claim 40, comprising successively moving a plurality of goods transport means in a row in the row direction.

43. The method of claim 40, wherein the aisle has a minimum length of at least two tile units in the column direction, for example a minimum length of at least three tile units in the column direction.

44. The method of claim 40, further comprising, during movement of the called goods transport means along the aisle, moving goods transport means in the row direction to close the aisle behind the called goods transport means.

45. The method of claim 40, further comprising moving a second called goods transport means from a tile unit in the grid to the output station by:
when the called goods transport means has passed by the row corresponding to the second called goods transport means, moving goods transport means in a column corresponding to the second called goods transport means in the row direction to create a second aisle in the column direction for the second called goods transport means, and
moving the second called goods transport means along the second aisle to the output station.

46. A tile unit for an automated storage and retrieval system, the tile unit comprising:
a seat defining a frame for assembly with other seats to define a framework of the automated storage and retrieval system, and
a removable section comprising a drive unit operable for driving movement of a goods transport means received on the tile unit,
wherein the removable section can be removed from the seat.

47. The tile unit of claim 46, wherein the removable section is attachable to the seat by a latch.

48. The tile unit of claim 47, wherein the removable section is attachable to the seat in a fastener-less manner.

49. The tile unit of claim 47, wherein the latch comprises a sliding latch that is moveable between a retracted position that permits removal of the removable section from the seat, and an extended position in which the sliding latch engages the frame to attach the removable section to the seat.

50. The tile unit of claim 46, wherein the removable section is removable from the seat by lifting the tile unit from the seat.

51. The tile unit of claim 46, wherein the tile unit is removable from an underside of the seat.

52. The tile unit of claim 46, wherein the seat comprises an electrical connector, and wherein the removable section comprises a corresponding electrical connector to connect with the electrical connector of the seat when the removable section is attached to the seat.

53. The tile unit of claim 52, wherein the seat comprises a circuit board having a port for power and/or communications connections.

54. The tile unit of claim 53, wherein the tile unit is connected to an adjacent tile unit and/or to a control system via the port.

55. The tile unit of claim 53, wherein the circuit board comprises a memory storing address information for the tile unit.

56. The tile unit of claim 46, wherein the frame of the seat is attachable to a plurality of other seats of other tile units to form a grid of tile units.

57. An automated storage and retrieval system for an order processing facility, the automated storage and retrieval system comprising a plurality of the tile units of claim 46, arranged in a grid such that the tile units form a substantially continuous substantially planar upper surface.

58. The automated goods storage and retrieval system of claim 57, wherein each tile unit has a communications connection with at least one other tile unit and/or a control system.

59. The automated goods storage and retrieval system of claim 58, further comprising a control system in communication with the network.

60. The automated goods storage and retrieval system of claim 58, wherein the plurality of tile units are configured to communicate with each other and/or with the control system using a point-to-point protocol.
